(19) United States
(12) Patent Application Publication
(10) Pub. No.: US 2022/0258107 A1
(43) Pub. Date: Aug. 18, 2022

(54) ULTRA-FINE BUBBLE GENERATING METHOD AND MANUFACTURING APPARATUS AND MANUFACTURING METHOD FOR ULTRA-FINE BUBBLE-CONTAINING LIQUID

(71) Applicant: CANON KABUSHIKI KAISHA, Tokyo (JP)

(72) Inventors: Hiroyuki Ishinaga, Tokyo (JP); Masahiko Kubota, Tokyo (JP); Akitoshi Yamada, Kanagawa (JP); Akira Yamamoto, Kanagawa (JP); Yoshiyuki Imanaka, Kanagawa (JP); Yumi Yanai, Kanagawa (JP); Teruo Ozaki, Kanagawa (JP); Toshio Kashino, Kanagawa (JP)

(21) Appl. No.: 17/732,663

(22) Filed: Apr. 29, 2022

Related U.S. Application Data
(63) Continuation of application No. PCT/JP2020/040734, filed on Oct. 30, 2020.

(30) Foreign Application Priority Data
Oct. 31, 2019 (JP) 2019-199395

(51) Int. Cl. B01F 23/231; B01F 35/80; B01F 35/90; B01F 21/00; B01F 23/21

(52) U.S. Cl. CPC B01F 23/231; B01F 35/80; B01F 2035/99; B01F 21/00; B01F 23/211; B01F 35/90

(57) ABSTRACT

A generating method for generating a UFB at a desired component ratio, and a manufacturing apparatus and a manufacturing method for a liquid containing a UFB at a desired component ratio are provided. To this end, a mixed solution in which multiple types of gases are dissolved at a predetermined ratio is generated, and a UFB is generated by heating the mixed solution with a heating element.

### CROSS-REFERENCE TO RELATED APPLICATIONS

This application is a Continuation of international Patent Application No. PCT/JP2020/040734, filed Oct. 30, 2020, which claims the benefit of Japanese Patent Application No. 2019-199395, filed Oct. 31, 2019, both of which are hereby incorporated by reference herein in their entirety.

### BACKGROUND OF THE INVENTION

### Field of the Invention

The present invention relates to a generating method for ultra-fine bubbles smaller than 1.0 μm in diameter and a manufacturing apparatus and a manufacturing method for an ultra-fine bubble-containing liquid.

### Background Art

Recently, there have been developed techniques for applying the features of fine bubbles such as microbubbles in micrometer-size in diameter and nanobubbles in nanometer-size in diameter. Especially, the utility of ultra-fine bubbles (Ultra Fine Bubble; hereinafter also referred to as “UFBs”) smaller than 1.0 μm in diameter has been confirmed in various fields.

In PTL 1, a fine air bubble generating apparatus that generates fine bubbles by jetting a pressurized liquid in which a gas is pressurized and dissolved from a depressurizing nozzle is disclosed. Additionally, in PTL 2, an apparatus that generates fine bubbles by repeating separating and converging of a flow of a gas mixed liquid by using a mixing unit.

Depending on the intended use, in order to effectively use generated UFBs, there may be a case where desired gases are required to be mixed at a proper ratio to be formed into UFBs. However, there has been no sufficient configuration to generate UFBs in which each gas component is at a proper component ratio, and there has been no other choice but to generate UFBs at a component ratio that is extremely unstable and is not guaranteed.

Given the circumstances, the present invention is to provide a UFB generating method by which a ratio of gas components in a single UFB is at a desired component ratio, and a manufacturing apparatus and a manufacturing method for a UFB-containing liquid in which a ratio of gas components in a single UFB is a desired component ratio.

### CITATION LIST

### Patent Literature

PTL 1: Japanese Patent Laid-Open No. 2014-104441
PTL 2: International Publication No. WO2009/088085

### SUMMARY OF THE INVENTION

To this end, an ultra-fine bubble generating method of the present invention includes: a mixed solution generating step to generate a mixed solution in which multiple types of gases are dissolved at a predetermined dissolving ratio; and an ultra-fine bubble generating step to generate an ultra-fine bubble by heating the mixed solution with a heating element and making film boiling on an interface between the mixed solution and the heating element.

Further features of the present invention will become apparent from the following description of exemplary embodiments with reference to the attached drawings.

### BRIEF DESCRIPTION OF THE DRAWINGS

FIG. 1 is a diagram illustrating an example of a UFB generating apparatus.

FIG. 2 is a schematic configuration diagram of a pre-processing unit.

FIG. 3A is a schematic configuration diagram of a dissolving unit.

FIG. 3B is a diagram for describing the dissolving states in a liquid.

FIG. 4 is a schematic configuration diagram of a T-UFB generating unit.

FIG. 5A is a diagrams for describing details of a heating element.

FIG. 5B is a diagrams for describing details of a heating element.

FIG. 6A is a diagrams for describing the states of film boiling on the heating element.

FIG. 6B is a diagrams for describing the states of film boiling on the heating element.

FIG. 7A is a diagrams illustrating the states of generation of UFBs caused by expansion of a film boiling bubble.

FIG. 7B is a diagrams illustrating the states of generation of UFBs caused by expansion of a film boiling bubble.

FIG. 7C is a diagrams illustrating the states of generation of UFBs caused by expansion of a film boiling bubble.

FIG. 7D is a diagrams illustrating the states of generation of UFBs caused by expansion of a film boiling bubble.

FIG. 8A is a diagrams illustrating the states of generation of UFBs caused by shrinkage of the film boiling bubble.

FIG. 8B is a diagrams illustrating the states of generation of UFBs caused by shrinkage of the film boiling bubble.

FIG. 8C is a diagrams illustrating the states of generation of UFBs caused by shrinkage of the film boiling bubble.

FIG. 9A is a diagrams illustrating the states of generation of UFBs caused by reheating of the liquid.

FIG. 9B is a diagrams illustrating the states of generation of UFBs caused by reheating of the liquid.

FIG. 9C is a diagrams illustrating the states of generation of UFBs caused by reheating of the liquid.

FIG. 10A is a diagrams illustrating the states of generation of UFBs caused by shock waves made by disappearance of the bubble generated by the film boiling.

FIG. 10B is a diagrams illustrating the states of generation of UFBs caused by shock waves made by disappearance of the bubble generated by the film boiling.

FIG. 11A is a diagrams illustrating a configuration example of a post-processing unit.

FIG. 11B is a diagrams illustrating a configuration example of a post-processing unit.

FIG. 11C is a diagrams illustrating a configuration example of a post-processing unit.

FIG. 12 is a schematic diagram of a multiple types of gases mixed-UFB generating system.

FIG. 13 is a schematic view illustrating a detailed configuration of the UFB generating system.

FIG. 14 is a diagram illustrating a UFB generating head and a mixing buffer chamber.

FIG. 15 is a diagram illustrating the UFB generating head.

FIG. 16 is a diagram illustrating the vicinity of a heating element in the UFB generating head.

FIG. 17A is a diagram illustrating states of a mixed gas UFB in a mixed solution.

FIG. 17B is a diagram illustrating states of a mixed gas UFB in a mixed solution.

FIG. 17C is a diagram illustrating states of a mixed gas UFB in a mixed solution.

FIG. 18 is a diagram illustrating driving of pumps to generate the mixed solution and concentrations of gases.

FIG. 19 is a diagram illustrating driving of the pumps to generate the mixed solution and concentrations of gases.

FIG. 20 is a flowchart illustrating processing for obtaining a concentration of the mixed solution.

FIG. 21 is a schematic view illustrating a detailed configuration of a UFB generating system.

FIG. 22 is a schematic view illustrating a detailed configuration of a UFB generating system.

### FIRST EMBODIMENT

### Description of Embodiments

A first embodiment of the present invention is described with reference to the drawings.

### <<Configuration of UFB Generating Apparatus>>

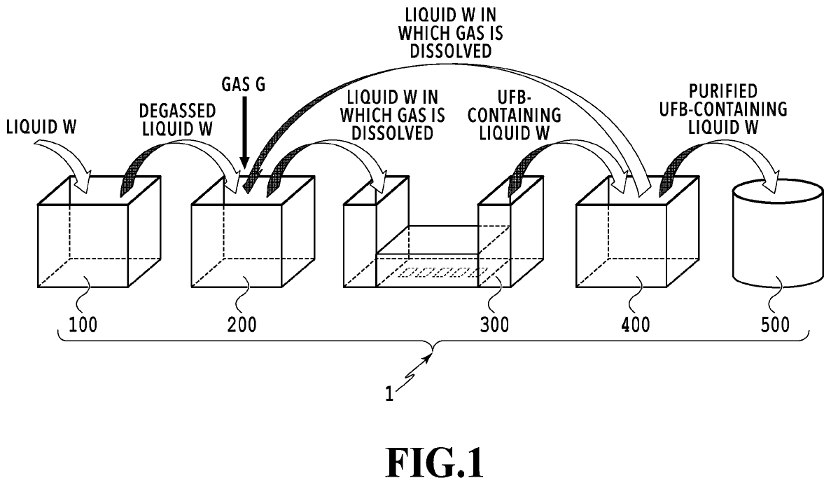

FIG. 1 is a diagram illustrating an example of a UFB generating apparatus applicable to the present invention. A UFB generating apparatus 1 of this embodiment includes a pre-processing unit 100, dissolving unit 200, a T-UFB generating unit 300, a post-processing unit 400, and a collecting unit 500. Each unit performs unique processing on a liquid W such as tap water supplied to the pre-processing unit 100 in the above order, and the thus-processed liquid W is collected as a T-UFB-containing liquid by the collecting unit 500. Functions and configurations of the units are described below. Although details are described later, UFBs generated by utilizing the film boiling caused by rapid heating are referred to as thermal-ultrafine bubbles (T-UFBs) in this specification.

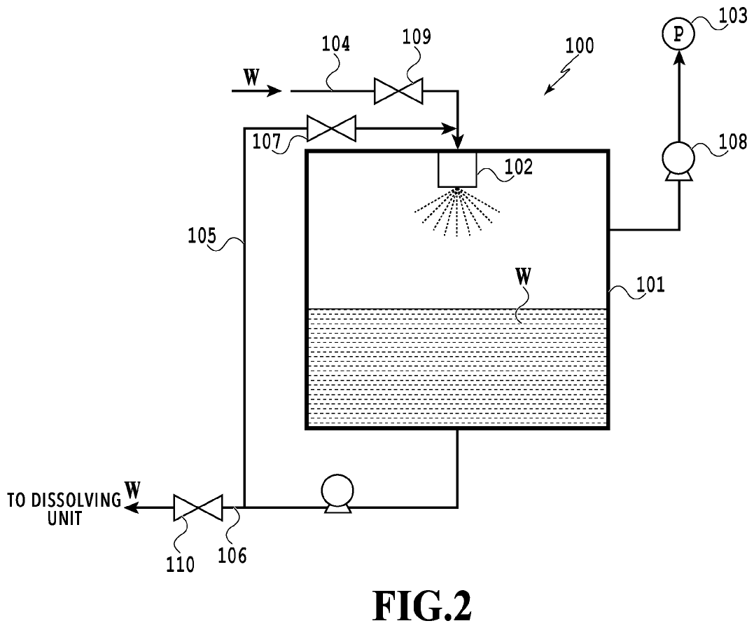

FIG. 2 is a schematic configuration diagram of the pre-processing unit 100. The pre-processing unit 100 of this embodiment performs a degassing treatment on the supplied liquid W. The pre-processing unit 100 mainly includes a degassing container 101, a shower head 102, a depressurizing pump 103, a liquid introduction passage 104, a liquid circulation passage 105, and a liquid discharge passage 106. For example, the liquid W such as tap water is supplied to the degassing container 101 that can retain the liquid from the liquid introduction passage 104 through a valve 109. In this process, the shower head 102 provided in the degassing container 101 sprays a mist of the liquid W in the degassing container 101. The shower head 102 is for prompting the gasification of the liquid W; however, a centrifugal and the like may be used instead as the mechanism for producing the gasification prompt effect.

When a certain amount of the liquid W is retained in the degassing container 101 and then the depressurizing pump 103 is activated with all the valves closed, already-gasified gas components are discharged, and gasification and discharge of gas components dissolved in the liquid W are also prompted. In this process, the internal pressure of the degassing container 101 may be depressurized to around several hundreds to thousands of Pa (1.0 Torr to 10.0 Torr) while checking a manometer 108. The gases to be removed by the degassing unit 100 includes nitrogen, oxygen, argon, carbon dioxide, and so on, for example.

The above-described degassing processing can be repeatedly performed on the same liquid W by utilizing the liquid circulation passage 105. Specifically, the shower head 102 is operated with the valve 109 of the liquid introduction passage 104 and a valve 110 of the liquid discharge passage 106 closed and a valve 107 of the liquid circulation passage 105 opened. This allows the liquid W retained in the degassing container 101 and degassed once to be resprayed in the degassing container 101 from the shower head 102. In addition, with the depressurizing pump 103 operated, the gasification processing by the shower head 102 and the degassing processing by the depressurizing pump 103 are repeatedly performed on the same liquid W. Every time the above processing utilizing the liquid circulation passage 105 is performed repeatedly, it is possible to decrease the gas components contained in the liquid W in stages. Once the liquid W degassed to a desired purity is obtained, the liquid W is transferred to the dissolving unit 200 through the liquid discharge passage 106 with the valve 110 opened.

FIG. 2 illustrates the degassing unit 100 that depressurizes the gas part to gasify the solute; however, the method of degassing the solution is not limited thereto. For example, a heating and boiling method for boiling the liquid W to gasify the solute may be employed, or a film degassing method for increasing the interface between the liquid and the gas using hollow fibers. A SEPAREL series (produced by DIC corporation) is commercially supplied as the degassing module using the hollow fibers. The SEPAREL series uses poly(4-methylpentene-1) (PMP) for the raw material of the hollow fibers and is used for removing air bubbles from ink and the like mainly supplied for a piezo head. In addition, two or more of an evacuating method, the heating and boiling method, and the film degassing method may be used together.

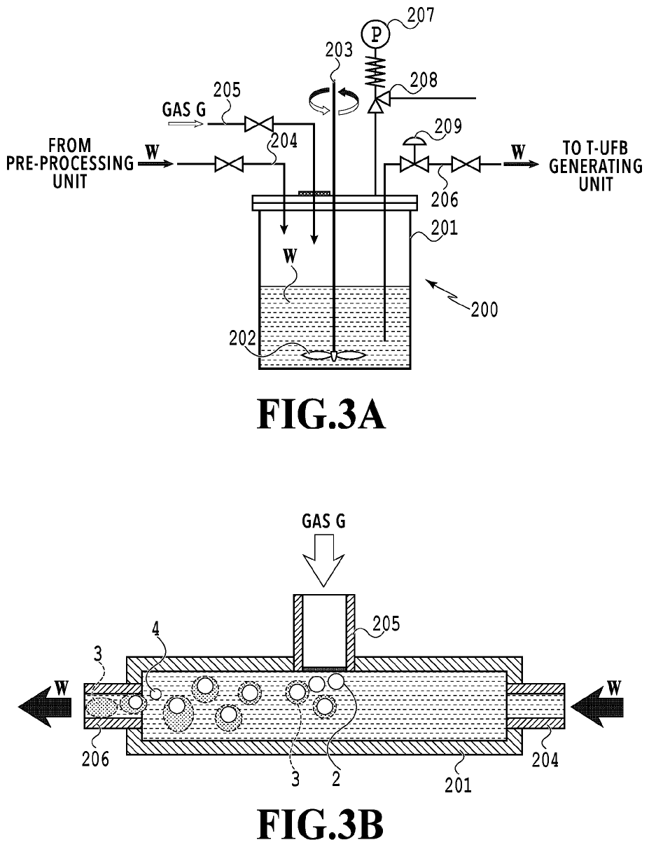

FIGS. 3A and 3B are a schematic configuration diagram of the dissolving unit 200 and a diagram for describing the dissolving states in the liquid. The dissolving unit 200 is a unit for dissolving a desired gas into the liquid W supplied from the pre-processing unit 100. The dissolving unit 200 of this embodiment mainly includes a dissolving container 201, a rotation shaft 203 provided with a rotation plate 202, a liquid introduction passage 204, a gas introduction passage 205, a liquid discharge passage 206, and a pressurizing pump 207.

The liquid W supplied from the pre-processing unit 100 is supplied and retained into the dissolving container 201 through the liquid introduction passage 204. Meanwhile, a gas G is supplied to the dissolving container 201 through the gas introduction passage 205.

Once predetermined amounts of the liquid W and the gas G are retained in the dissolving container 201, the pressurizing pump 207 is activated to increase the internal pressure of the dissolving container 201 to about 0.5 MPa. A safety valve 208 is arranged between the pressurizing pump 207 and the dissolving container 201. With the rotation plate 202 in the liquid rotated via the rotation shaft 203, the gas G supplied to the dissolving container 201 is transformed into air bubbles, and the contact area between the gas G and the liquid W is increased to prompt the dissolution into the liquid W. This operation is continued until the solubility of the gas G reaches almost the maximum saturation solubility. In this case, a unit for decreasing the temperature of the liquid may be provided to dissolve the gas as much as possible. When the gas is with low solubility, it is also possible to increase the internal pressure of the dissolving container 201 to 0.5 MPa or higher. In this case, the material and the like of the container need to be the optimum for safety sake.

Once the liquid Win which the components of the gas G are dissolved at a desired concentration is obtained, the liquid W is discharged through the liquid discharge passage 206 and supplied to the T-UFB generating unit 300. In this process, a back-pressure valve 209 adjusts the flow pressure of the liquid W to prevent excessive increase of the pressure during the supplying.

FIG. 3B is a diagram schematically illustrating the dissolving states of the gas G put in the dissolving container 201. An air bubble 2 containing the components of the gas G put in the liquid W is dissolved from a portion in contact with the liquid W. The air bubble 2 thus shrinks gradually, and a gas-dissolved liquid 3 then appears around the air bubble 2. Since the air bubble 2 is affected by the buoyancy, the air bubble 2 may be moved to a position away from the center of the gas-dissolved liquid 3 or be separated out from the gas-dissolved liquid 3 to become a residual air bubble 4. Specifically, in the liquid W to be supplied to the T-UFB generating unit 300 through the liquid discharge passage 206, there is a mix of the air bubbles 2 surrounded by the gas-dissolved liquids 3 and the air bubbles 2 and the gas-dissolved liquids 3 separated from each other.

The gas-dissolved liquid 3 in FIG. 3B means “a region of the liquid W in which the dissolution concentration of the gas G mixed therein is relatively high.” In the gas components actually dissolved in the liquid W in either case where the gas-dissolved liquid 3 is surrounding the air bubble 2 or separated from the air bubble 2, the concentration of the gas components in the center of the region is the highest, and the concentration is continuously decreased as away from the center. That is, although the region of the gas-dissolved liquid 3 is surrounded by a broken line in FIG. 3(b) for the sake of explanation, such a clear boundary does not actually exist. In addition, in the present invention, a gas that cannot be dissolved completely may be accepted to exist in the form of an air bubble in the liquid.

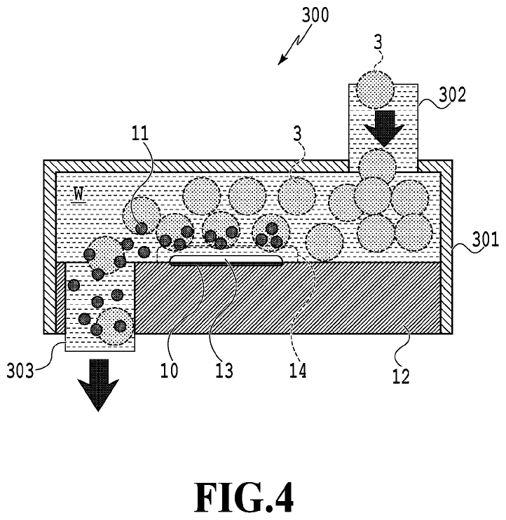

FIG. 4 is a schematic configuration diagram of the T-UFB generating unit 300. The T-UFB generating unit 300 mainly includes a chamber 301, a liquid introduction passage 302, and a liquid discharge passage 303. The flow from the liquid introduction passage 302 to the liquid discharge passage 303 through the chamber 301 is formed by a not-illustrated flow pump. Various pumps including a diaphragm pump, a gear pump, and a screw pump may be employed as the flow pump. The gas-dissolved liquid 3 of the gas G put by the dissolving unit 200 is mixed in the liquid W introduced from the liquid introduction passage 302.

An element substrate 12 provided with a heating element 10 is arranged on a bottom section of the chamber 301. With a predetermined voltage pulse applied to the heating element 10, a bubble 13 generated by the film boiling (hereinafter, also referred to as a film boiling bubble 13) is generated in a region in contact with the heating element 10. Then, an ultrafine bubble (UFB) 11 containing the gas G is generated caused by expansion and shrinkage of the film boiling bubble 13. As a result, a UFB-containing liquid W containing many UFBs 11 is discharged from the liquid discharge passage 303.

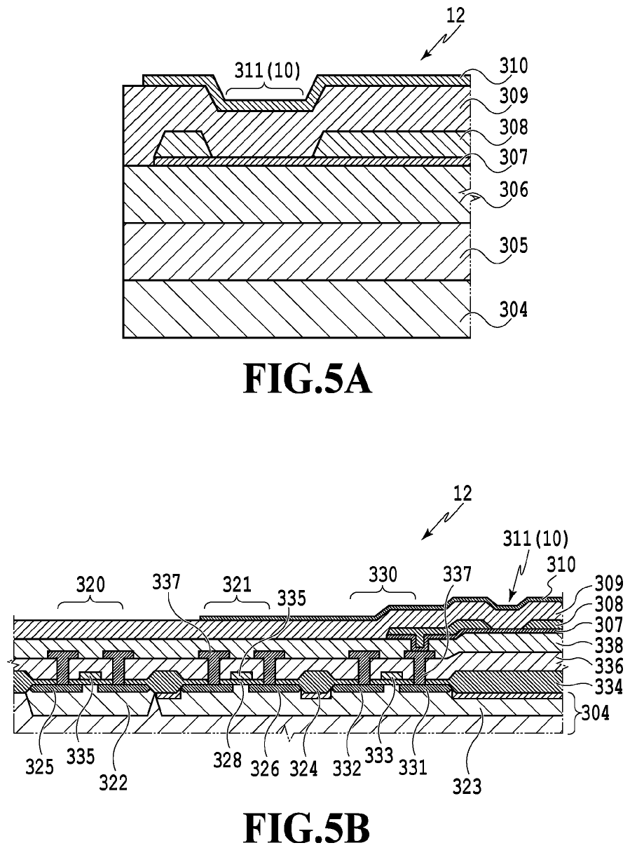

FIGS. 5A and 5B are diagrams for illustrating a detailed configuration of the heating element 10. FIG. 5A illustrates a closeup view of the heating element 10, and FIG. 5B illustrates a cross-sectional view of a wider region of the element substrate 12 including the heating element 10.

As illustrated in FIG. 5A, in the element substrate 12 of this embodiment, a thermal oxide film 305 as a heat-accumulating layer and an interlaminar film 306 also served as a heat-accumulating layer are laminated on a surface of a silicon substrate 304. An SiO₂ film or an SiN film may be used as the interlaminar film 306. A resistive layer 307 is formed on a surface of the interlaminar film 306, and a wiring 308 is partially formed on a surface of the resistive layer 307. An Al-alloy wiring of Al, Al—Si, Al—Cu, or the like may be used as the wiring 308. A protective layer 309 made of an SiO₂ film or an Si₃N₄ film is formed on surfaces of the wiring 308, the resistive layer 307, and the interlaminar film 306.

A cavitation-resistant film 310 for protecting the protective layer 309 from chemical and physical impacts due to the heat evolved by the resistive layer 307 is formed on a portion and around the portion on the surface of the protective layer 309, the portion corresponding to a heat-acting portion 311 that eventually becomes the heating element 10. A region on the surface of the resistive layer 307 in which the wiring 308 is not formed is the heat-acting portion 311 in which the resistive layer 307 evolves heat. The heating portion of the resistive layer 307 on which the wiring 308 is not formed functions as the heating element (heater) 10. As described above, the layers in the element substrate 12 are sequentially formed on the surface of the silicon substrate 304 by a semiconductor production technique, and the heat-acting portion 311 is thus provided on the silicon substrate 304.

The configuration illustrated in FIG. 5A is an example, and various other configurations are applicable. For example, a configuration in which the laminating order of the resistive layer 307 and the wiring 308 is opposite, and a configuration in which an electrode is connected to a lower surface of the resistive layer 307 (so-called a plug electrode configuration) are applicable. In other words, as described later, any configuration may be applied as long as the configuration allows the heat-acting portion 311 to heat the liquid for generating the film boiling in the liquid.

FIG. 5B is an example of a cross-sectional view of a region including a circuit connected to the wiring 308 in the element substrate 12. An N-type well region 322 and a P-type well region 323 are partially provided in a top layer of the silicon substrate 304, which is a P-type conductor. AP-MOS 320 is formed in the N-type well region 322 and an N-MOS 321 is formed in the P-type well region 323 by introduction and diffusion of impurities by the ion implantation and the like in the general MOS process.

The P-MOS 320 includes a source region 325 and a drain region 326 formed by partial introduction of N-type or P-type impurities in a top layer of the N-type well region 322, a gate wiring 335, and so on. The gate wiring 335 is deposited on a part of a top surface of the N-type well region 322 excluding the source region 325 and the drain region 326, with a gate insulation film 328 of several hundreds of A in thickness interposed between the gate wiring 335 and the top surface of the N-type well region 322.

The N-MOS 321 includes the source region 325 and the drain region 326 formed by partial introduction of N-type or P-type impurities in a top layer of the P-type well region 323, the gate wiring 335, and so on. The gate wiring 335 is deposited on a part of a top surface of the P-type well region 323 excluding the source region 325 and the drain region 326, with the gate insulation film 328 of several hundreds of A in thickness interposed between the gate wiring 335 and the top surface of the P-type well region 323. The gate wiring 335 is made of polysilicon of 3000 Å to 5000 Å in thickness deposited by the CVD method. A C-MOS logic is constructed with the P-MOS 320 and the N-MOS 321.

In the P-type well region 323, an N-MOS transistor 330 for driving an electrothermal conversion element (heating resistance element) is formed on a portion different from the portion including the N-MOS 321. The N-MOS transistor 330 includes a source region 332 and a drain region 331 partially provided in the top layer of the P-type well region 323 by the steps of introduction and diffusion of impurities, a gate wiring 333, and so on. The gate wiring 333 is deposited on a part of the top surface of the P-type well region 323 excluding the source region 332 and the drain region 331, with the gate insulation film 328 interposed between the gate wiring 333 and the top surface of the P-type well region 323.

In this example, the N-MOS transistor 330 is used as the transistor for driving the electrothermal conversion element. However, the transistor for driving is not limited to the N-MOS transistor 330, and any transistor may be used as long as the transistor has a capability of driving multiple electrothermal conversion elements individually and can implement the above-described fine configuration. Although the electrothermal conversion element and the transistor for driving the electrothermal conversion element are formed on the same substrate in this example, those may be formed on different substrates separately.

An oxide film separation region 324 is formed by field oxidation of 5000 Å to 10000 Å in thickness between the elements, such as between the P-MOS 320 and the N-MOS 321 and between the N-MOS 321 and the N-MOS transistor 330. The oxide film separation region 324 separates the elements. A portion of the oxide film separation region 324 corresponding to the heat-acting portion 311 functions as a heat-accumulating layer 334, which is the first layer on the silicon substrate 304.

An interlayer insulation film 336 including a PSG film, a BPSG film, or the like of about 7000 Å in thickness is formed by the CVD method on each surface of the elements such as the P-MOS 320, the N-MOS 321, and the N-MOS transistor 330. After the interlayer insulation film 336 is made flat by heat treatment, an Al electrode 337 as a first wiring layer is formed in a contact hole penetrating through the interlayer insulation film 336 and the gate insulation film 328. On surfaces of the interlayer insulation film 336 and the Al electrode 337, an interlayer insulation film 338 including an SiO₂ film of 10000 Å to 15000 Å in thickness is formed by a plasma CVD method. On the surface of the interlayer insulation film 338, a resistive layer 307 including a TaSiN film of about 500 Å in thickness is formed by a co-sputter method on portions corresponding to the heat-acting portion 311 and the N-MOS transistor 330. The resistive layer 307 is electrically connected with the Al electrode 337 near the drain region 331 via a through-hole formed in the interlayer insulation film 338. On the surface of the resistive layer 307, the wiring 308 of Al as a second wiring layer for a wiring to each electrothermal conversion element is formed. The protective layer 309 on the surfaces of the wiring 308, the resistive layer 307, and the interlayer insulation film 338 includes an SiN film of 3000 Å in thickness formed by the plasma CVD method. The cavitation-resistant film 310 deposited on the surface of the protective layer 309 includes a thin film of about 2000 Å in thickness, which is at least one metal selected from the group consisting of Ta, Fe, Ni, Cr, Ge, Ru, Zr, Ir, and the like. Various materials other than the above-described TaSiN such as TaN0.8, CrSiN, TaAl, WSiN, and the like can be applied as long as the material can generate the film boiling in the liquid.

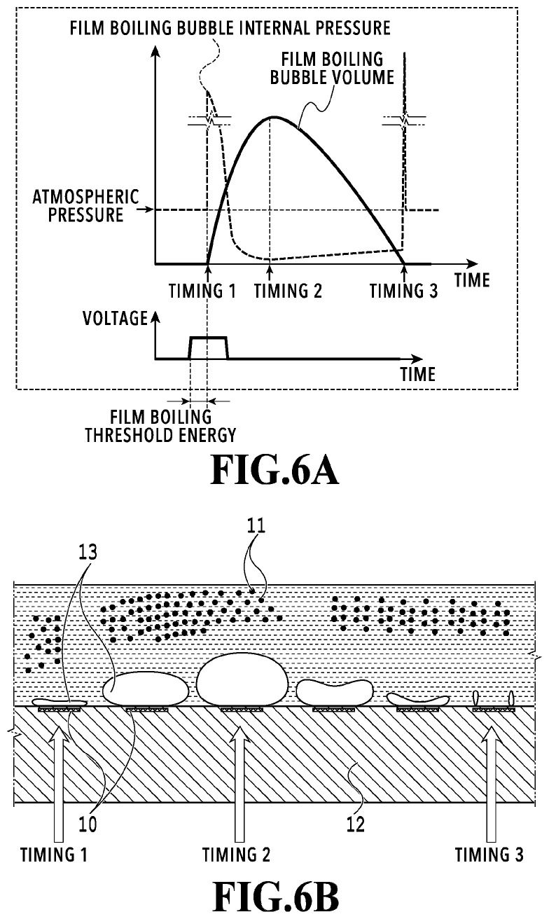

FIGS. 6A and 6B are diagrams illustrating the states of the film boiling when a predetermined voltage pulse is applied to the heating element 10. In this case, the case of generating the film boiling under atmospheric pressure is described. In FIG. 6A, the horizontal axis represents time. The vertical axis in the lower graph represents a voltage applied to the heating element 10, and the vertical axis in the upper graph represents the volume and the internal pressure of the film boiling bubble 13 generated by the film boiling. On the other hand, FIG. 6B illustrates the states of the film boiling bubble 13 in association with timings 1 to 3 shown in FIG. 6A. Each of the states is described below in chronological order. The UFBs 11 generated by the film boiling as described later are mainly generated near a surface of the film boiling bubble 13. The states illustrated in FIG. 6B are the states where the UFBs 11 generated by the generating unit 300 are resupplied to the dissolving unit 200 through the circulation route, and the liquid containing the UFBs 11 is resupplied to the liquid passage of the generating unit 300, as illustrated in FIG. 1.

Before a voltage is applied to the heating element 10, the atmospheric pressure is substantially maintained in the chamber 301. Once a voltage is applied to the heating element 10, the film boiling is generated in the liquid in contact with the heating element 10, and a thus-generated air bubble (hereinafter, referred to as the film boiling bubble 13) is expanded by a high pressure acting from inside (timing 1). A bubbling pressure in this process is expected to be around 8 to 10 MPa, which is a value close to a saturation vapor pressure of water.

The time for applying a voltage (pulse width) is around 0.5 usec to 10.0 usec, and the film boiling bubble 13 is expanded by the inertia of the pressure obtained in timing 1 even after the voltage application. However, a negative pressure generated with the expansion is gradually increased inside the film boiling bubble 13, and the negative pressure acts in a direction to shrink the film boiling bubble 13. After a while, the volume of the film boiling bubble 13 becomes the maximum in timing 2 when the inertial force and the negative pressure are balanced, and thereafter the film boiling bubble 13 shrinks rapidly by the negative pressure.

In the disappearance of the film boiling bubble 13, the film boiling bubble 13 disappears not in the entire surface of the heating element 10 but in one or more extremely small regions. For this reason, on the heating element 10, further greater force than that in the bubbling in timing 1 is generated in the extremely small region in which the film boiling bubble 13 disappears (timing 3).

The generation, expansion, shrinkage, and disappearance of the film boiling bubble 13 as described above are repeated every time a voltage pulse is applied to the heating element 10, and new UFBs 11 are generated each time.

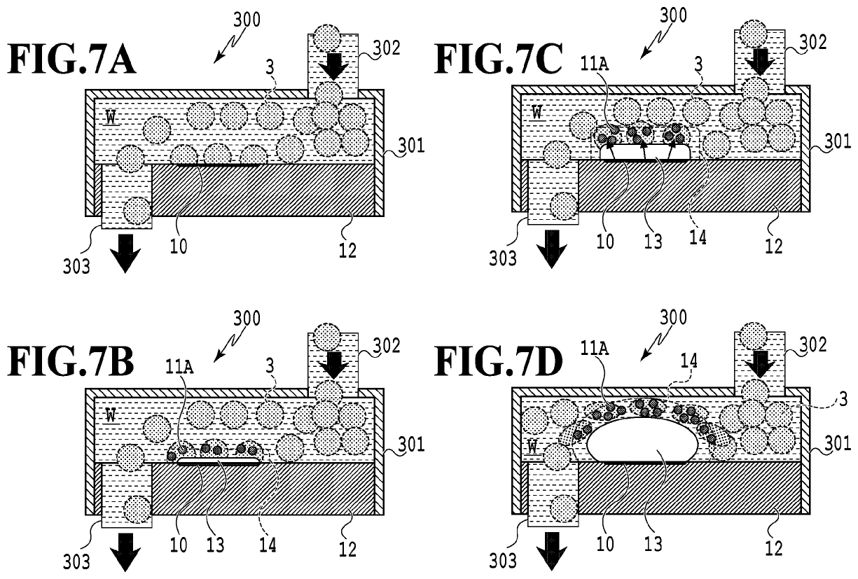

The states of generation of the UFBs 11 in each process of the generation, expansion, shrinkage, and disappearance of the film boiling bubble 13 are further described in detail with reference to FIGS. 7A to 10.

FIGS. 7A to 7B are diagrams schematically illustrating the states of generation of the UFBs 11 caused by the generation and the expansion of the film boiling bubble 13. FIG. 7A illustrates the state before the application of a voltage pulse to the heating element 10. The liquid W in which the gas-dissolved liquids 3 are mixed flows inside the chamber 301.

FIG. 7B illustrates the state where a voltage is applied to the heating element 10, and the film boiling bubble 13 is evenly generated in almost all over the region of the heating element 10 in contact with the liquid W. When a voltage is applied, the surface temperature of the heating element 10 rapidly increases at a speed of 10° C./pec. The film boiling occurs at a time point when the temperature reaches almost 300° C., and the film boiling bubble 13 is thus generated.

Thereafter, the surface temperature of the heating element 10 keeps increasing to around 600 to 800° C. during the pulse application, and the liquid around the film boiling bubble 13 is rapidly heated as well. In FIG. 7B, a region of the liquid that is around the film boiling bubble 13 and to be rapidly heated is indicated as a not-yet-bubbling high temperature region 14. The gas-dissolved liquid 3 within the not-yet-bubbling high temperature region 14 exceeds the thermal dissolution limit and is precipitated to become the UFB. The thus-precipitated air bubbles have diameters of around 10 nm to 100 nm and large gas-liquid interface energy. Thus, the air bubbles float independently in the liquid W without disappearing in a short time. In this embodiment, the air bubbles generated by the thermal action from the generation to the expansion of the film boiling bubble 13 are called first UFBs 11A.

FIG. 7C illustrates the state where the film boiling bubble 13 is expanded. Even after the voltage pulse application to the heating element 10, the film boiling bubble 13 continues expansion by the inertia of the force obtained from the generation thereof, and the not-yet-bubbling high temperature region 14 is also moved and spread by the inertia. Specifically, in the process of the expansion of the film boiling bubble 13, the gas-dissolved liquid 3 within the not-yet-bubbling high temperature region 14 is precipitated as a new air bubble and becomes the first UFB 11A.

FIG. 7D illustrates the state where the film boiling bubble 13 has the maximum volume. As the film boiling bubble 13 is expanded by the inertia, the negative pressure inside the film boiling bubble 13 is gradually increased along with the expansion, and the negative pressure acts to shrink the film boiling bubble 13. At a time point when the negative pressure and the inertial force are balanced, the volume of the film boiling bubble 13 becomes the maximum, and then the shrinkage is started.

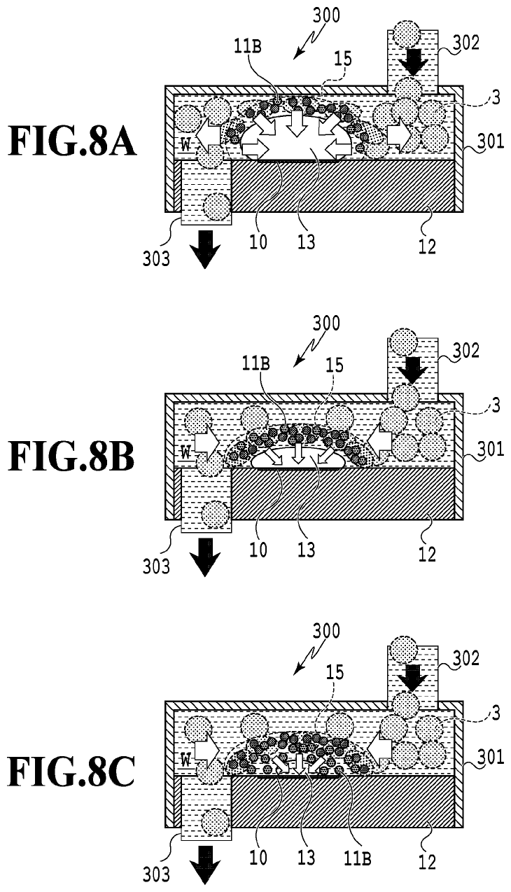

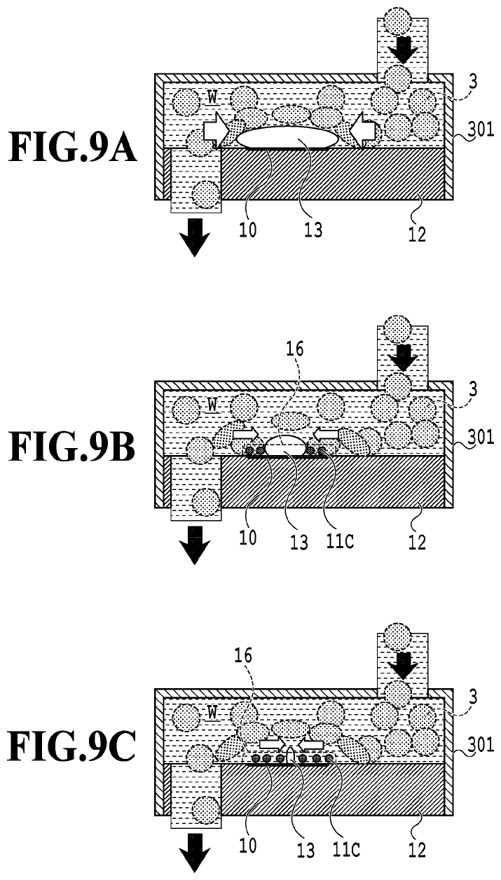

In the shrinking stage of the film boiling bubble 13, there are UFBs generated by the processes illustrated in FIGS. 8A to 8C (second UFBs 11B) and UFBs generated by the processes illustrated in FIGS. 9A to 9C (third UFBs). It is considered that these two processes are made simultaneously.

FIGS. 8A to 8C are diagrams illustrating the states of generation of the UFBs 11 caused by the shrinkage of the film boiling bubble 13. FIG. 8A illustrates the state where the film boiling bubble 13 starts shrinking. Although the film boiling bubble 13 starts shrinking, the surrounding liquid W still has the inertial force in the expansion direction. Because of this, the inertial force acting in the direction of going away from the heating element 10 and the force going toward the heating element 10 caused by the shrinkage of the film boiling bubble 13 act in a surrounding region extremely close to the film boiling bubble 13, and the region is depressurized. The region is indicated in FIG. 8A as a not-yet-bubbling negative pressure region 15.

The gas-dissolved liquid 3 within the not-yet-bubbling negative pressure region 15 exceeds the pressure dissolution limit and is precipitated to become an air bubble. The thus-precipitated air bubbles have diameters of about 100 nm and thereafter float independently in the liquid W without disappearing in a short time. In this embodiment, the air bubbles precipitated by the pressure action during the shrinkage of the film boiling bubble 13 are called the second UFBs 11B.

FIG. 8B illustrates a process of the shrinkage of the film boiling bubble 13. The shrinking speed of the film boiling bubble 13 is accelerated by the negative pressure, and the not-yet-bubbling negative pressure region 15 is also moved along with the shrinkage of the film boiling bubble 13. Specifically, in the process of the shrinkage of the film boiling bubble 13, the gas-dissolved liquids 3 within a part over the not-yet-bubbling negative pressure region 15 are precipitated one after another and become the second UFBs 11B.

FIG. 8C illustrates the state immediately before the disappearance of the film boiling bubble 13. Although the moving speed of the surrounding liquid W is also increased by the accelerated shrinkage of the film boiling bubble 13, a pressure loss occurs due to a flow passage resistance in the chamber 301. As a result, the region occupied by the not-yet-bubbling negative pressure region 15 is further increased, and a number of the second UFBs 11B are generated.

FIGS. 9A to 9C are diagrams illustrating the states of generation of the UFBs by reheating of the liquid W during the shrinkage of the film boiling bubble 13. FIG. 9A illustrates the state where the surface of the heating element 10 is covered with the shrinking film boiling bubble 13.

FIG. 9B illustrates the state where the shrinkage of the film boiling bubble 13 has progressed, and a part of the surface of the heating element 10 comes in contact with the liquid W. In this state, there is heat left on the surface of the heating element 10, but the heat is not high enough to cause the film boiling even if the liquid W comes in contact with the surface. A region of the liquid to be heated by coming in contact with the surface of the heating element 10 is indicated in FIG. 9B as a not-yet-bubbling reheated region 16. Although the film boiling is not made, the gas-dissolved liquid 3 within the not-yet-bubbling reheated region 16 exceeds the thermal dissolution limit and is precipitated. In this embodiment, the air bubbles generated by the reheating of the liquid W during the shrinkage of the film boiling bubble 13 are called the third UFBs 11C.

FIG. 9C illustrates the state where the shrinkage of the film boiling bubble 13 has further progressed. The smaller the film boiling bubble 13, the greater the region of the heating element 10 in contact with the liquid W, and the third UFBs 11C are generated until the film boiling bubble 13 disappears.

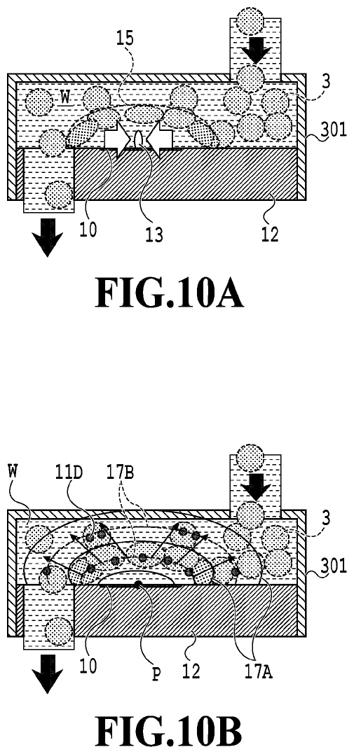

FIGS. 10A and 10B are diagrams illustrating the states of generation of the UFBs caused by an impact from the disappearance of the film boiling bubble 13 generated by the film boiling (that is, a type of cavitation). FIG. 10A illustrates the state immediately before the disappearance of the film boiling bubble 13. In this state, the film boiling bubble 13 shrinks rapidly by the internal negative pressure, and the not-yet-bubbling negative pressure region 15 surrounds the film boiling bubble 13.

FIG. 10B illustrates the state immediately after the film boiling bubble 13 disappears at a point P. When the film boiling bubble 13 disappears, acoustic waves ripple concentrically from the point P as a starting point due to the impact of the disappearance. The acoustic wave is a collective term of an elastic wave that is propagated through anything regardless of gas, liquid, and solid. In this embodiment, coarse of the liquid W, which are a high pressure surface 17A and a low pressure surface 17B of the liquid W, are propagated alternately.

In this case, the gas-dissolved liquid 3 within the not-yet-bubbling negative pressure region 15 is resonated by the shock waves made by the disappearance of the film boiling bubble 13, and the gas-dissolved liquid 3 exceeds the pressure dissolution limit and the phase transition is made in timing when the low pressure surface 17B passes therethrough. Specifically, a number of air bubbles are precipitated in the not-yet-bubbling negative pressure region 15 simultaneously with the disappearance of the film boiling bubble 13. In this embodiment, the air bubbles generated by the shock waves made by the disappearance of the film boiling bubble 13 are called fourth UFBs 11D.

The fourth UFBs 11B generated by the shock waves made by the disappearance of the film boiling bubble 13 suddenly appear in an extremely short time (1 μS or less) in an extremely narrow thin film-shaped region. The diameter is sufficiently smaller than that of the first to third UFBs, and the gas-liquid interface energy is higher than that of the first to third UFBs. For this reason, it is considered that the fourth UFBs 11D have different characteristics from the first to third UFBs 11A to 11C and generate different effects.

Additionally, the fourth UFBs 11D are evenly generated in many parts of the region of the concentric sphere in which the shock waves are propagated, and the fourth UFBs 11D evenly exist in the chamber 301 from the generation thereof. Although many first to third UFBs already exist in the timing of the generation of the fourth UFBs 11D, the presence of the first to third UFBs does not affect the generation of the fourth UFBs 11D greatly. It is also considered that the first to third UFBs do not disappear due to the generation of the fourth UFBs 11D.

As described above, it is expected that the UFBs 11 are generated in the multiple stages from the generation to the disappearance of the film boiling bubble 13 by the heat generation of the heating element 10. The first UFBs 11A, the second UFBs 11B, and the third UFBs 11C are generated near the surface of the film boiling bubble generated by the film boiling. In this case, near means a region within about 20 μm from the top surface of the film boiling bubble. The fourth UFBs 11D are generated in a region through which the shock waves are propagated when the air bubble disappears. Although the above example illustrates the stages to the disappearance of the film boiling bubble 13, the way of generating the UFBs is not limited thereto. For example, with the generated film boiling bubble 13 communicating with the atmospheric air before the bubble disappearance, the UFBs can be generated also if the film boiling bubble 13 does not reach the exhaustion.

Next, remaining properties of the UFBs are described. The higher the temperature of the liquid, the lower the dissolution properties of the gas components, and the lower the temperature, the higher the dissolution properties of the gas components. In other words, the phase transition of the dissolved gas components is prompted and the generation of the UFBs becomes easier as the temperature of the liquid is higher. The temperature of the liquid and the solubility of the gas are in the inverse relationship, and the gas exceeding the saturation solubility is transformed into air bubbles and precipitated into the liquid as the liquid temperature increases.

Therefore, when the temperature of the liquid rapidly increases from normal temperature, the dissolution properties are decreased without stopping, and the generation of the UFBs starts. The thermal dissolution properties are decreased as the temperature increases, and a number of the UFBs are generated.

Conversely, when the temperature of the liquid decreases from normal temperature, the dissolution properties of the gas are increased, and the generated UFBs are more likely to be liquefied. However, the temperature is sufficiently lower than normal temperature. Additionally, since the once generated UFBs have a high internal pressure and large gas-liquid interface energy even when the temperature of the liquid decreases, it is highly unlikely that there is exerted a sufficiently high pressure to break such a gas-liquid interface. In other words, the once generated UFBs do not disappear easily as long as the liquid is stored at normal temperature and normal pressure.

In this embodiment, the first UFBs 11A described with FIGS. 7A to 7C and the third UFBs 11C described with FIGS. 9A to 9C can be described as UFBs that are generated by utilizing such thermal dissolution properties of gas.

On the other hand, in the relationship between the pressure and the dissolution properties of liquid, the higher the pressure of the liquid, the higher the dissolution properties of the gas, and the lower the pressure, the lower the dissolution properties. In other words, the phase transition to the gas of the gas-dissolved liquid dissolved in the liquid is prompted and the generation of the UFBs becomes easier as the pressure of the liquid is lower. Once the pressure of the liquid becomes lower than normal pressure, the dissolution properties are decreased without stopping, and the generation of the UFBs starts. The pressure dissolution properties are decreased as the pressure decreases, and a number of the UFBs are generated.

Conversely, when the pressure of the liquid increases to be higher than normal temperature, the dissolution properties of the gas are increased, and the generated UFBs are more likely to be liquefied. However, the pressure is sufficiently higher than the atmospheric pressure. Additionally, since the once generated UFBs have a high internal pressure and large gas-liquid interface energy even when the pressure of the liquid increases, it is highly unlikely that there is exerted a sufficiently high pressure to break such a gas-liquid interface. In other words, the once generated UFBs do not disappear easily as long as the liquid is stored at normal temperature and normal pressure.

In this embodiment, the second UFBs 11B described with FIGS. 8A to 8C and the fourth UFBs 11D described with FIGS. 10A to 10C can be described as UFBs that are generated by utilizing such pressure dissolution properties of gas.

Those first to fourth UFBs generated by different causes are described individually above; however, the above-described generation causes occur simultaneously with the event of the film boiling. Thus, at least two types of the first to the fourth UFBs may be generated at the same time, and these generation causes may cooperate to generate the UFBs. It should be noted that it is common for all the generation causes to be induced by the volume change of the film boiling bubble generated by the film boiling phenomenon. In this specification, the method of generating the UFBs by utilizing the film boiling caused by the rapid heating as described above is referred to as a thermal-ultrafine bubble (T-UFB) generating method. Additionally, the UFBs generated by the T-UFB generating method are referred to as T-UFBs, and the liquid containing the T-UFBs generated by the T-UFB generating method is referred to as a T-UFB-containing liquid.

Almost all the air bubbles generated by the T-UFB generating method are 1.0 μm or less, and milli-bubbles and microbubbles are unlikely to be generated. That is, the T-UFB generating method allows dominant and efficient generation of the UFBs. Additionally, the T-UFBs generated by the T-UFB generating method have larger gas-liquid interface energy than that of the UFBs generated by a conventional method, and the T-UFBs do not disappear easily as long as being stored at normal temperature and normal pressure. Moreover, even if new T-UFBs are generated by new film boiling, it is possible to prevent disappearance of the already generated T-UFBs due to the impact from the new generation. That is, it can be said that the number and the concentration of the T-UFBs contained in the T-UFB-containing liquid have the hysteresis properties depending on the number of times the film boiling is made in the T-UFB-containing liquid. In other words, it is possible to adjust the concentration of the T-UFBs contained in the T-UFB-containing liquid by controlling the number of the heating elements provided in the T-UFB generating unit 300 and the number of the voltage pulse application to the heating elements.

Reference to FIG. 1 is made again. Once the T-UFB-containing liquid W with a desired UFB concentration is generated in the T-UFB generating unit 300, the ultra-fine bubble-containing liquid W is supplied to the post-processing unit 400.

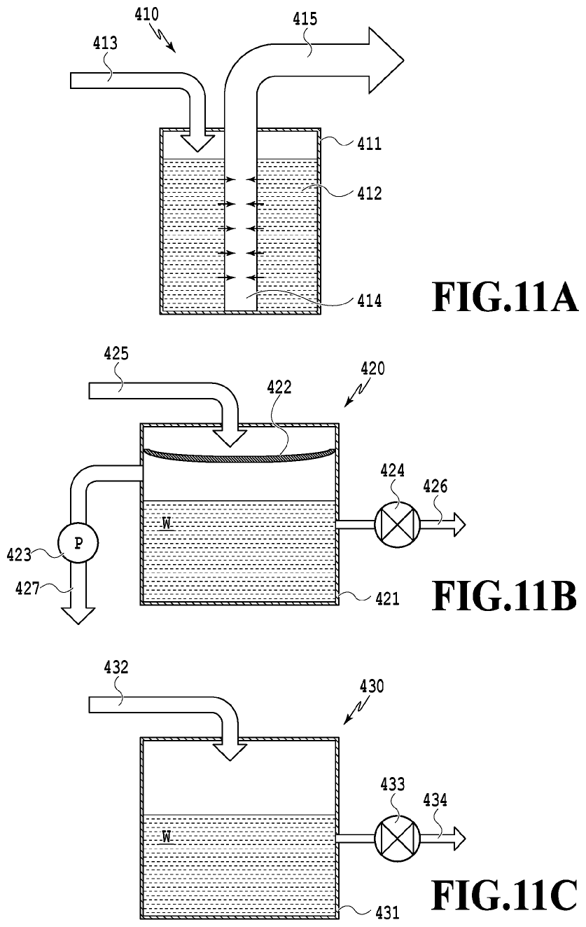

FIGS. 11A to 11C are diagrams illustrating configuration examples of the post-processing unit 400 of this embodiment. The post-processing unit 400 of this embodiment removes impurities in the UFB-containing liquid W in stages in the order from inorganic ions, organic substances, and insoluble solid substances.

FIG. 11A illustrates a first post-processing mechanism 410 that removes the inorganic ions. The first post-processing mechanism 410 includes an exchange container 411, cation exchange resins 412, a liquid introduction passage 413, a collecting pipe 414, and a liquid discharge passage 415. The exchange container 411 stores the cation exchange resins 412. The UFB-containing liquid W generated by the T-UFB generating unit 300 is injected to the exchange container 411 through the liquid introduction passage 413 and absorbed into the cation exchange resins 412 such that the cations as the impurities are removed. Such impurities include metal materials peeled off from the element substrate 12 of the T-UFB generating unit 300, such as SiO₂, SiN, SiC, Ta, Al₂O₃, Ta₂O₅, and Ir.

The cation exchange resins 412 are synthetic resins in which a functional group (ion exchange group) is introduced in a high polymer matrix having a three-dimensional network, and the appearance of the synthetic resins are spherical particles of around 0.4 to 0.7 mm. A general high polymer matrix is the styrene-divinylbenzene copolymer, and the functional group may be that of methacrylic acid series and acrylic acid series, for example. However, the above material is an example. As long as the material can remove desired inorganic ions effectively, the above material can be changed to various materials. The UFB-containing liquid W absorbed in the cation exchange resins 412 to remove the inorganic ions is collected by the collecting pipe 414 and transferred to the next step through the liquid discharge passage 415.

FIG. 11B illustrates a second post-processing mechanism 420 that removes the organic substances. The second post-processing mechanism 420 includes a storage container 421, a filtration filter 422, a vacuum pump 423, a valve 424, a liquid introduction passage 425, a liquid discharge passage 426, and an air suction passage 427. Inside of the storage container 421 is divided into upper and lower two regions by the filtration filter 422. The liquid introduction passage 425 is connected to the upper region of the upper and lower two regions, and the air suction passage 427 and the liquid discharge passage 426 are connected to the lower region thereof. Once the vacuum pump 423 is driven with the valve 424 closed, the air in the storage container 421 is discharged through the air suction passage 427 to make the pressure inside the storage container 421 negative pressure, and the UFB-containing liquid W is thereafter introduced from the liquid introduction passage 425. Then, the UFB-containing liquid W from which the impurities are removed by the filtration filter 422 is retained into the storage container 421.

The impurities removed by the filtration filter 422 include organic materials that may be mixed at a tube or each unit, such as organic compounds including silicon, siloxane, and epoxy, for example. A filter film usable for the filtration filter 422 includes a filter of a sub-μm-mesh that can remove bacteria, and a filter of a nm-mesh that can remove virus.

After a certain amount of the UFB-containing liquid W is retained in the storage container 421, the vacuum pump 423 is stopped and the valve 424 is opened to transfer the T-UFB-containing liquid in the storage container 421 to the next step through the liquid discharge passage 426. Although the vacuum filtration method is employed as the method of removing the organic impurities herein, a gravity filtration method and a pressurized filtration can also be employed as the filtration method using a filter, for example.

FIG. 11C illustrates a third post-processing mechanism 430 that removes the insoluble solid substances. The third post-processing mechanism 430 includes a precipitation container 431, a liquid introduction passage 432, a valve 433, and a liquid discharge passage 434.

First, a predetermined amount of the UFB-containing liquid W is retained into the precipitation container 431 through the liquid introduction passage 432 with the valve 433 closed, and leaving it for a while. Meanwhile, the solid substances in the UFB-containing liquid W are precipitated onto the bottom of the precipitation container 431 by gravity. Among the bubbles in the UFB-containing liquid, relatively large bubbles such as microbubbles are raised to the liquid surface by the buoyancy and also removed from the UFB-containing liquid. After a lapse of sufficient time, the valve 433 is opened, and the UFB-containing liquid W from which the solid substances and large bubbles are removed is transferred to the collecting unit 500 through the liquid discharge passage 434. The example of applying the three post-processing mechanisms in sequence is shown in this embodiment; however, it is not limited thereto, and a needed post-processing mechanism may be employed when necessary.

Reference to FIG. 1 is made again. The T-UFB-containing liquid W from which the impurities are removed by the post-processing unit 400 may be directly transferred to the collecting unit 500 or may be put back to the dissolving unit 200 again. In the latter case, the gas dissolution concentration of the T-UFB-containing liquid W that is decreased due to the generation of the T-UFBs can be compensated to the saturated state again by the dissolving unit 200. If new T-UFBs are generated by the T-UFB generating unit 300 after the compensation, it is possible to further increase the concentration of the UFBs contained in the T-UFB-containing liquid with the above-described properties. That is, it is possible to increase the concentration of the contained UFBs by the number of circulations through the dissolving unit 200, the T-UFB generating unit 300, and the post-processing unit 400, and it is possible to transfer the UFB-containing liquid W to the collecting unit 500 after a predetermined concentration of the contained UFBs is obtained.

The collecting unit 500 collects and preserves the UFB-containing liquid W transferred from the post-processing unit 400. The T-UFB-containing liquid collected by the collecting unit 500 is a UFB-containing liquid with high purity from which various impurities are removed.

In the collecting unit 500, the UFB-containing liquid W may be classified by the size of the T-UFBs by performing some stages of filtration processing. Since it is expected that the temperature of the T-UFB-containing liquid W obtained by the T-UFB method is higher than normal temperature, the collecting unit 500 may be provided with a cooling unit. The cooling unit may be provided to a part of the post-processing unit 400.

The schematic description of the UFB generating apparatus 1 is given above; however, it is needless to say that the illustrated multiple units can be changed, and not all of them need to be prepared. Depending on the type of the liquid W and the gas G to be used and the intended use of the T-UFB-containing liquid to be generated, a part of the above-described units may be omitted, or another unit other than the above-described units may be added.

For example, when the gas to be contained by the UFBs is the atmospheric air, the degassing unit 100 and the dissolving unit 200 can be omitted. On the other hand, when multiple kinds of gases are desired to be contained by the UFBs, another dissolving unit 200 may be added.

The units for removing the impurities as described in FIGS. 11A to 11C may be provided upstream of the T-UFB generating unit 300 or may be provided both upstream and downstream thereof. When the liquid to be supplied to the UFB generating apparatus is tap water, rain water, contaminated water, or the like, there may be included organic and inorganic impurities in the liquid. If such a liquid W including the impurities is supplied to the T-UFB generating unit 300, there is a risk of deteriorating the heating element 10 and inducing the salting-out phenomenon. With the mechanisms as illustrated in FIGS. 11A to 11C provided upstream of the T-UFB generating unit 300, it is possible to remove the above-described impurities previously.

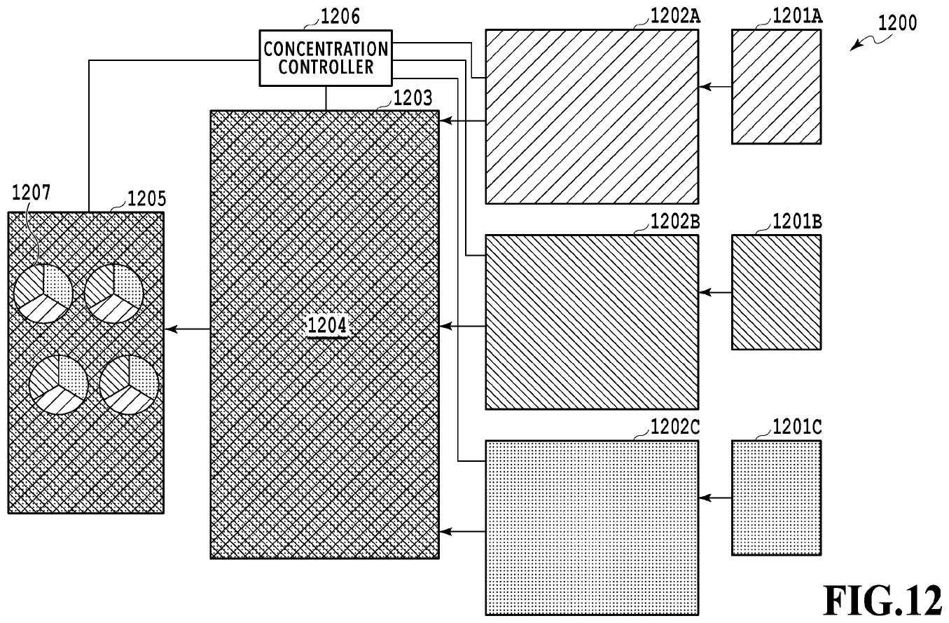

FIG. 12 is a schematic diagram illustrating multiple types of gases mixed-ultra-fine bubble generating system (hereinafter, simply referred to as a UFB generating system) 1200. The UFB generating system 1200 can generate UFBs in which a single UFB has a component of three types of gases mixed at a desired component ratio. In the UFB generating system 1200, solutions in which three types of gases, a gas A, a gas B, and a gas C, are respectively dissolved are generated, and thereafter, a mixed solution in which the solutions are mixed is generated by a mixed solution generating system. The mixed solution is heated by a heating element to generate a UFB, and thus a UFB having a component of the three types of gases mixed is generated. Hereinafter, a UFB containing three types of gases as described above is referred to as a mixed gas UFB 1207. Note that, although three types of gases are mixed in the configuration in the present embodiment, it is also possible to develop to a configuration of using two to many gases as needed. Hereinafter, details of the UFB generating system 1200 are described.

The UFB generating system 1200 includes an A gas generator 1201A connected with an A gas solution chamber 1202A, a B gas tank 1201B connected with a B gas solution chamber 1202B, and a C gas tank 1201C connected with a C gas solution chamber 1202C. Additionally, the UFB generating system 1200 includes a solution mixing system 1203 connected with each of the gas solution chambers, a concentration controller 1206 that controls a concentration of a solution of each gas in the solution mixing system 1203, and a UFB generating unit 1205 that generates a UFB. The concentration controller 1206 is connected to the solution mixing system 1203 and the UFB generating unit 1205 and detects a gas component concentration balance of a mixed solution 1204 and the mixed gas UFB 1207 and controls the supplying amounts from the solution chambers.

Hereinafter, the gas A is described; note that, similar processing with a similar apparatus configuration as that for the gas A is performed also on the gas B and the gas C. The gas A is transferred from the A gas generator 1201A to the A gas solution chamber 1202A, and an A gas solution is generated in the A gas solution chamber 1202A. The A gas solution generated in the A gas solution chamber 1202A is supplied to the solution mixing system 1203 while the concentration within the solution mixing system 1203 is adjusted by the concentration controller 1206. The mixed solution 1204 that has the concentration within the solution mixing system 1203 adjusted is supplied to the UFB generating unit 1205, and the mixed gas UFB 1207 is generated in the UFB generating unit 1205.

The mixed gas UFB 1207 is a UFB having a component of three types of gas components mixed, and although the three types of gases are illustrated in separation for description, the gases are mixed in actuality, and there are no separation lines. Additionally, although the size is enlarged in illustration to make it more visible, the UFB exists in a size equal to or smaller than 1 μm in diameter in actuality.

The gas to be dissolved into the liquid can be optionally selected as a gas inside the UFB. For example, hydrogen, helium, oxygen, nitrogen, methane, fluorine, neon, carbon dioxide, ozone, argon, chlorine, ethane, propane, air, and a gas selected from the group consisting of a mixed gas containing the above can be included as the gas to be dissolved. Additionally, a gas component of a compound of various elements can also be included. With the above gases dissolved at a desired ratio, the mixed gas UFB 1207 at a desired gas component proportion can be obtained.

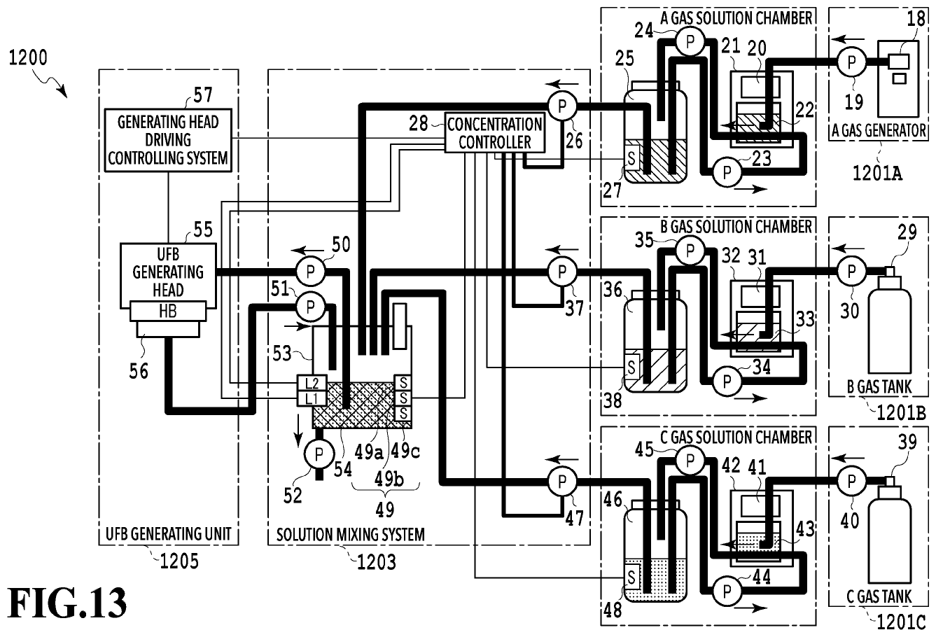

FIG. 13 is a schematic view illustrating a detailed configuration of the UFB generating system 1200. As the A gas generator 1201A, a device or the like that generates oxygen by pressurized nitrogen zeolite adsorption such as an oxygen PSA method can be used. The generated gas is transferred to an A gas dissolving chamber (gas dissolving chamber) 21 by a pump 19. The gas A is transferred to an A gas dissolving tank 22 provided in the A gas solution chamber 1202A, put into a bubble state by bubbling, and dissolved into a liquid retained in the A gas dissolving tank 22. The retained liquid is circulated between an A gas solution buffer 25 and the A gas dissolving tank 22 by a pump 23 and a pump 24. A discharging device 20 is provided in the A gas dissolving chamber 21, and the discharging device 20 applies corona discharge and the like to the gas A as needed to put into the radical state by bringing into the plasma state so as to make it easy to be dissolved into a solution.

The solution in the A gas solution buffer 25 is transferred to a mixing buffer chamber 53 by a concentration control pump 26. The concentration control pump 26 is connected with a concentration controller 28 and controls the transportation amount such that the inside of the mixing buffer chamber 53 has a desired concentration in accordance with the solution concentration from a concentration sensor 27 in the A gas dissolving buffer 25 and the solution concentration from a concentration sensor 49 in the mixing buffer chamber 53. As with the solution from the A gas dissolving buffer 25, corresponding solutions from a B gas dissolving buffer 36 and a C gas dissolving buffer 46 are transferred to the mixing buffer chamber 53, and the three types of solutions are mixed with each other. Descriptions of the gas B and the gas C are omitted because they are similar to the gas A.

In the mixing buffer chamber 53, a solution derived from the gas A, a solution derived from the gas B, and a solution derived from the gas C exist in a state of being mixed with each other. As the mix ratio of the gases in the mixing buffer chamber 53, the concentration controller 28 obtains corresponding concentration information from concentration sensors 27, 38, 48, and 49 and controls concentration control pumps 26, 37, and 47 to control the component ratio of each gas so as to be a desired mix ratio.

The mixed solution in the mixing buffer chamber 53 is circulated by pumps 50 and 51 through a UFB generating head 55 and a cap 56. The mixed solution is heated and makes film boiling in the process of passing through the UFB generating head 55, and thus the mixed gas UFB 1207 containing at least a part of the gas A, the gas B, and the gas C dissolved in the solution is generated. Additionally, in accordance with the controlled gas dissolving ratio of the solution, the gas component proportion in a UFB can be controlled. Moreover, based on the concentration data obtained from the concentration controller 28, a head driving controlling system 57 controls driving of the UFB generating head 55, and thus a UFB can be generated under the driving conditions optimized for the gas dissolving ratio of the solution. Furthermore, the head driving controlling system 57 can change the driving conditions to obtain a UFB generating ratio varied from an original ratio. For example, if the gas is a type that is easier to be generated by setting the heating conditions to a high temperature, it is possible to obtain a desired ratio by performing processing of increasing the component proportion under the high temperature condition and processing of decreasing the component under the low temperature condition.

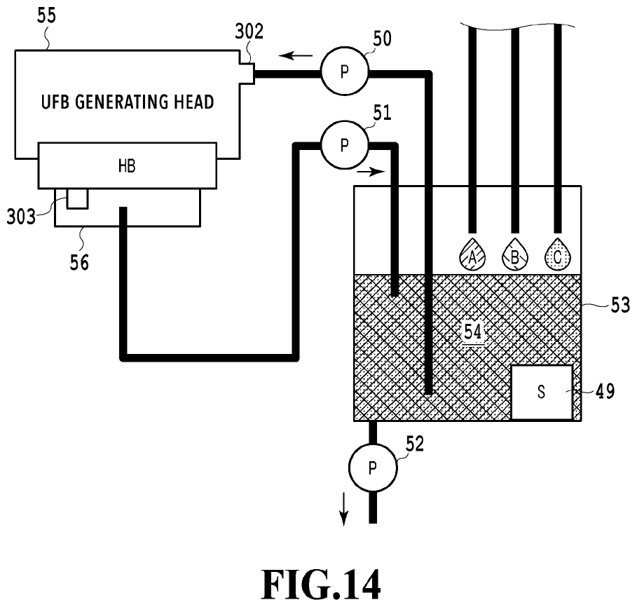

FIG. 14 is a diagram illustrating the UFB generating head 55 and the mixing buffer chamber 53. The mixing buffer chamber 53 is supplied with the A gas solution in which the gas A is dissolved (vertical lines), the B gas solution in which the gas B is dissolved (horizontal lines), and the C gas solution in which the gas C is dissolved (dots) from supplying tubes, respectively. The A gas solution, the B gas solution, and the C gas solution are mixed with each other in the mixing buffer chamber 53 to be a mixed solution 54. In the UFB generating head 55, UFBs are generated by heating the mixed solution 54, which is supplied to the UFB generating head 55 by the pump 50, by a heating heater (heating element 10) of a heater board HB provided on the UFB generating head 55 and making film boiling.

The mixed solution 54 containing the UFBs generated is ejected from the heater board HB to the cap 56 by way of a liquid discharge passage 303, sucked by the pump 51, and returned to the mixing buffer chamber 53. Thereafter, the mixed solution 54 is supplied to the UFB generating head 55 by the pump 50. In the mixed solution 54, the UFB concentration is increased by repeating the circulation between the UFB generating head 55 and the mixing buffer chamber 53, and the mixed solution 54 that has a more accurate desired concentration and contains UFBs at a desired gas component ratio is obtained by using the concentration sensor 49. The mixed solution 54 is ejected to the outside from the mixing buffer chamber 53 by an ejection pump 52.

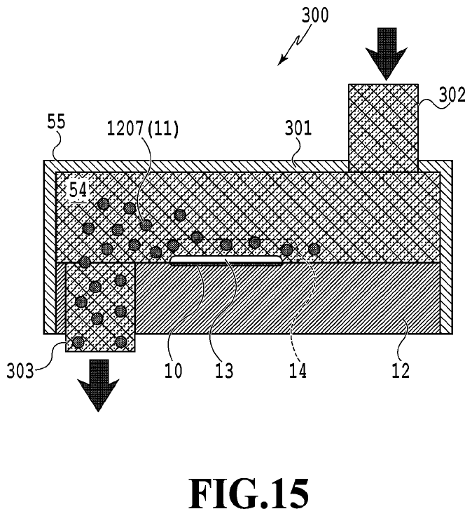

FIG. 15 is a diagram illustrating the UFB generating head 55. The mixed solution 54 on a heating element contact surface is immediately heated, and once reaching 300° C. or more, the film boiling bubble 13 is generated in which the entire surface of an effective bubbling region (inner side except a heating element outer periphery 1 μm) of the heating element 10 bubbles at once. In this process, the mixed solution 54 in contact with the film boiling bubble 13 forms the not-yet-bubbling high temperature region 14 steeply (100 μS or less), and the mixed solution 54 included in the region exceeds the dissolution limit and generates many dissolution limit precipitation gas bubbles everywhere in the region almost at the same time. Since the mixed solution 54 intervenes, the bubbles generated almost at the same time keep independent in the form of a small air bubble (100 nm) without bonding. This air bubble (hereinafter, referred to as a UFB) is the mixed gas UFB 1207. The mixed gas UFB 1207 thus generated in the UFB generating chamber 301 is ejected to the cap 56 by way of the liquid discharge passage 303 with the solution.

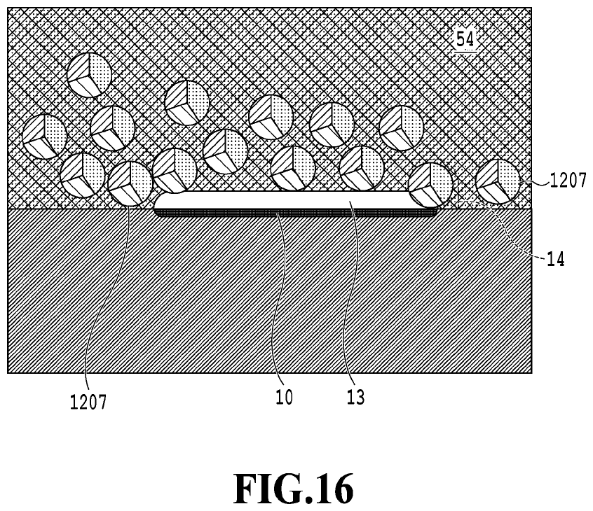

FIG. 16 is a diagram illustrating the vicinity of the heating element 10 in the UFB generating head 55. In FIG. 16, the three types of gases precipitated from the mixed solution 54 are included in the mixed gas UFB 1207 generated, and the situation is schematically illustrated so as to show the component proportion. The gases A, B, and C are represented by vertical lines, horizontal lines, and dots, and the components are indicated at a ratio of about 30%, 30%, and 40% in the form of a pie chart. Since it is a mixed gas, the gases are not separated like the above in actuality but the gases are indicated in the separated form for the sake of description. Additionally, although the size of the mixed gas UFB 1207 is enlarged for description, it is in the size of 1 μm or less. As illustrated in FIG. 16, the component ratio of the gases in the UFB during the UFB generation reflects the ratio of the gases dissolved in the mixed solution 54.

Various methods in various fields may be considered for the intended use of the mixed gas UFB 1207. For example, a great effect is expected in cultivation of plants used for building material, food, and the like. There are elements required to grow plants that are light, carbon dioxide, and water necessary for photosynthesis, and additionally, phosphorus, nitrogen, and potassium necessary for leaf, stem, and root, and moreover, sulfur, a small amount of metal element, chlorine, and the like. In order to allow plants to efficiently absorb those nutrients, the timing for providing and the component ratio are important, and the key to grow plants with high efficiency is to appropriately prepare an appropriate nutrient ratio and provide it in a growth period, like a large amount of oxygen for the timing of sprouting, potassium for growing root in the initial stage, a small amount of sulfur for leaf, increase in phosphorus for the season of blooming and bearing fruit, and nitrogen throughout the entire period.

In the present invention, a gas portion (nitrogen, oxygen, and hydrogen), an element formed into a gas component as a compound (sulfur oxides and the like), and the like of those nutrients are mixed at a more proper ratio in accordance with the growth period of the plant to be formed into the UFBs, and the growth of the plant can be encouraged dramatically. Note that, it is necessary to avoid mixing of gases that are unsuitable for mixing (for example, mixing of O₂ and O₃ that promotes degradation of O₃, or mixing of acid and alkali that causes neutralization).

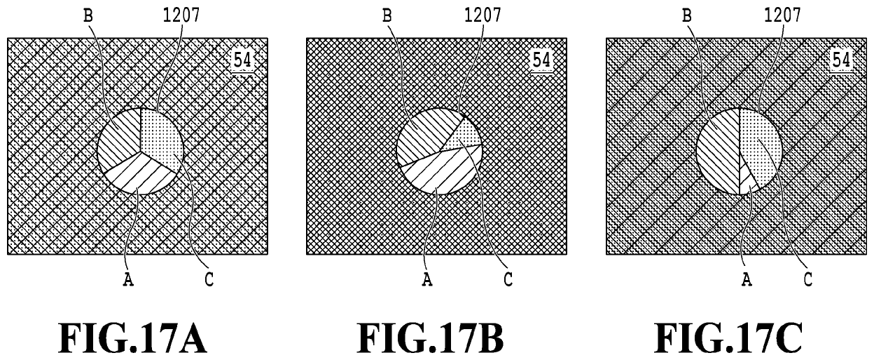

FIGS. 17A to 17C are diagrams illustrating states of the mixed gas UFB 1207 in the mixed solution 54. If the component ratios of the gas A, the gas B, and the gas C dissolved in the mixed solution 54 are different to each other, the ratios of the gas components in the mixed gas UFB 1207 are also different in accordance with the component ratios of the gas A, the gas B, and the gas C dissolved in the mixed solution 54.

The mixed solution 54 illustrated in FIG. 17A has a component ratio at which the solution derived from the gas A, the solution derived from the gas B, and the solution derived from the gas C are about 33%, respectively. In a case of generating the mixed gas UFB 1207 by using the above mixed solution 54, the component proportions of the gas A, the gas B, and the gas C in the mixed gas UFB 1207 are about 33%, respectively.

The mixed solution 54 illustrated in FIG. 17B has a component ratio at which the solution derived from the gas A, the solution derived from the gas B, and the solution derived from the gas C are about 45%, about 40%, and about 15%, respectively. In a case of generating the mixed gas UFB 1207 by using the above mixed solution 54, the component proportions of the gas A, the gas B, and the gas C in the mixed gas UFB 1207 are about 45%, about 40%, and about 15%, respectively.

The mixed solution 54 illustrated in FIG. 17C has a component ratio at which the solution derived from the gas A, the solution derived from the gas B, and the solution derived from the gas C are about 10%, about 50%, and about 40%, respectively. In a case of generating the mixed gas UFB 1207 by using the above mixed solution 54, the component proportions of the gas A, the gas B, and the gas C in the mixed gas UFB 1207 are about 10%, about 50%, and about 40%, respectively.

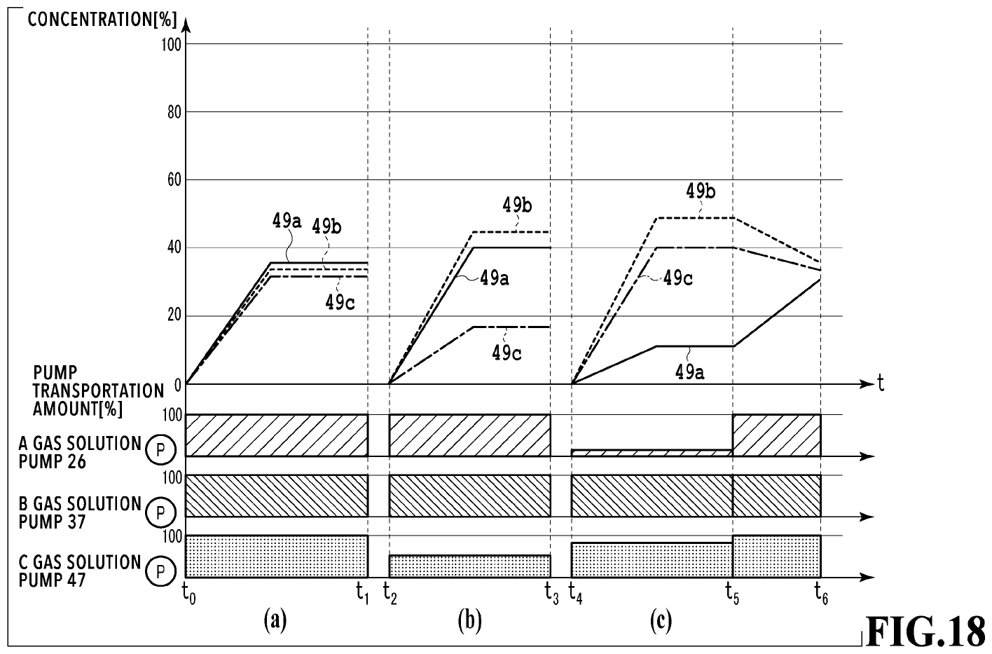

Portion (a) to (c) of FIG. 18 correspond to FIGS. 17A to 17C are diagrams illustrating driving of the pumps to generate the mixed solution 54 at a corresponding component ratio and the concentrations of the corresponding gas components.

A case illustrated in FIG. 17A where the mixed solution 54 in which the component proportions of the gas A, the gas B, and the gas C are about 33%, respectively, is obtained is described. As illustrated in portion (a) of FIG. 18, the driving rate of each of the pump 26, the pump 37, and the pump 47 is 100% to be controlled to the almost same transportation amount. Pure water or the like is reserved in the mixing buffer chamber 53 into which the solution flows in. Once the solution of each gas is supplied, the solution concentration in the mixing buffer chamber 53 is gradually increased. In this process, with a low concentration liquid ejected by using the ejection pump 52 together, the rise in the concentration can be increased.

If the pump 26, the pump 37, and the pump 47 are driven at the driving rate of 100% from a clock time to, until reaching a clock time t₁, the solution derived from the gas A, the solution derived from the gas B, and the solution derived from the gas C reach about 33%, respectively.

A case illustrated in FIG. 17B where the mixed solution 54 in which the component proportions of the gas A, the gas B, and the gas C are about 45%, about 40%, and about 15%, respectively, is obtained is described. As illustrated in portion (b) of FIG. 18, the pump 26, the pump 37, and the pump 47 are controlled to the transportation ratio of about 45%, about 40%, and about 15%, respectively. Pure water or the like is reserved in the mixing buffer chamber 53 before a clock time t₂. As the solution of each gas is supplied, the solution concentration in the mixing buffer chamber 53 is gradually increased. Until reaching a clock time t₃, the solution derived from the gas A, the solution derived from the gas B, and the solution derived from the gas C reach the component ratio of about 45%, about 40%, and about 15%, respectively.

A case illustrated in FIG. 17C where the mixed solution 54 in which the component proportions of the gas A, the gas B, and the gas C are about 10%, about 50%, and about 40%, respectively, is obtained at a clock time t₅, and thereafter the mixed solution 54 in which the component proportions are about 33%, respectively, is obtained at a clock time t₆ is described. As illustrated in portion (c) of FIG. 18, the pump 26, the pump 37, and the pump 47 are controlled to the transportation ratio of about 10%, about 50%, and about 40%, respectively. Pure water or the like is reserved in the mixing buffer chamber 53 before a clock time t₄. As the solution of each gas is supplied, the solution concentration in the mixing buffer chamber 53 is gradually increased. Until reaching the clock time t₅, the solution derived from the gas A, the solution derived from the gas B, and the solution derived from the gas C reach the component ratio of about 10%, about 50%, and about 40%, respectively.

Thereafter, the control is varied continuously to set the driving rate of the pump 26, the pump 37, and the pump 47 to about 100%, respectively, and thus the mix concentration in the mixing buffer chamber 53 is changed to be about 33%, respectively, until the clock time t₆. In this way, a solution at a desired concentration ratio can be obtained.

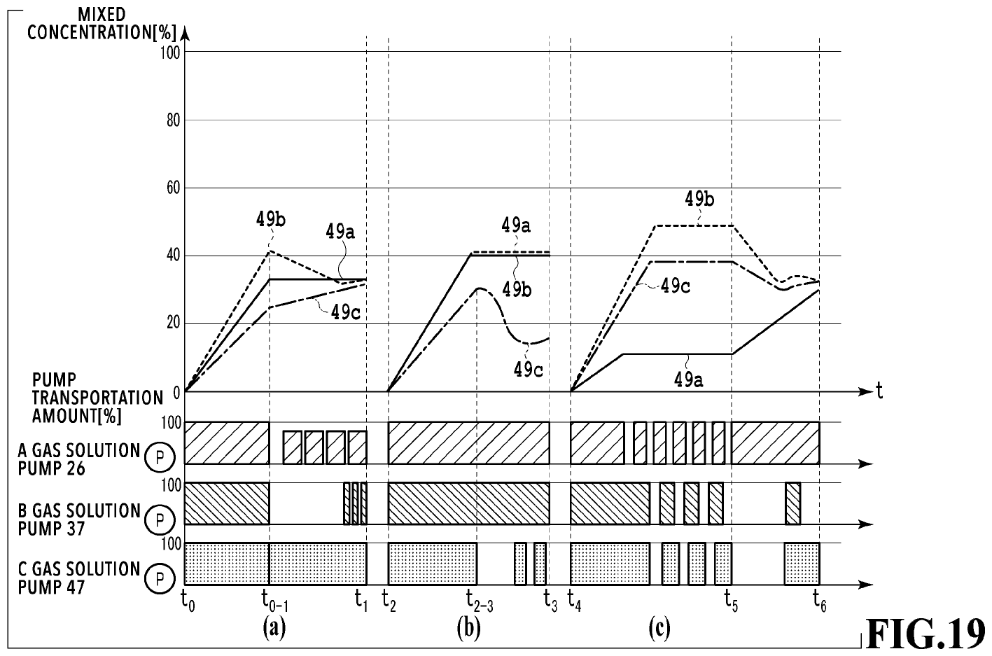

Portion (a) to (c) of FIG. 19 correspond to FIGS. 17A to 17C and are diagrams illustrating driving of the pumps to generate the mixed solution 54 at a corresponding component ratio by feedback control of the concentration sensors and the transportation pumps and the concentrations of the corresponding gas components. In a case where a desired concentration ratio is not obtained due to variations in the solution transportation capacities of the transportation pumps and change in state by the mixing, the mixed solution 54 at a desired component ratio can be obtained by the feedback control of the concentration sensors and the transportation pumps.

A case illustrated in FIG. 17A where the mixed solution 54 in which the component proportions of the gas A, the gas B, and the gas C are about 33%, respectively, is obtained is described. As illustrated in portion (c) of FIG. 19, the driving rate of each of the pump 26, the pump 37, and the pump 47 is 100% to be controlled to the almost same transportation amount from the clock time t₀ to a clock time T₁₋₂. In a case where there are variations in the transportation amounts of the pumps, and the component proportions in the mixed solution 54 are varied at the time point of a clock time T₀₋₁ as illustrated in portion (a) of FIG. 19, the pumps 37 and 47 are driven by the feedback control based on the information from the concentration sensors. With this, until the clock time t₁, the solution derived from the gas A, the solution derived from the gas B, and the solution derived from the gas C reach the component ratio of about 33%, respectively.

A case illustrated in FIG. 17B where the mixed solution 54 in which the component proportions of the gas A, the gas B, and the gas C are about 45%, about 40%, and about 15%, respectively, is obtained is described. As illustrated in portion (b) of FIG. 19, the transportation ratios of the pump 26, the pump 37, and the pump 47 are controlled to about 45%, about 40%, and about 15%, respectively. In a case where the transportation amount of the pump 47 that transports the solution derived from the gas C is large, and the component ratio of the gas C is high at the time point of a clock time T2-3, the pump 47 is driven while reducing speed by the feedback control based on the information from the concentration sensors. With this, until the clock time t₃, the solution derived from the gas A, the solution derived from the gas B, and the solution derived from the gas C reach the component ratio of about 45%, about 40%, and about 15%, respectively.

A case illustrated in FIG. 17C where the mixed solution 54 in which the component proportions of the gas A, the gas B, and the gas C are about 10%, about 50%, and about 40%, respectively, is obtained at the clock time t₅, and thereafter the mixed solution 54 in which the component proportions are about 33%, respectively, is obtained at the clock time t₆ is described. First, as illustrated in portion (c) of FIG. 19, the transportation ratios of the pump 26, the pump 37, and the pump 47 are controlled to about 10%, about 50%, and about 40%, respectively. Until reaching the clock time t₅, the solution derived from the gas A, the solution derived from the gas B, and the solution derived from the gas C reach the component ratio of about 10%, about 50%, and about 40%, respectively.

However, at the time point of the clock time t₅, the concentration of the solution derived from the gas C is slightly lower than 40%, which is the target, and a reduction in the transportation capacity of the pump 47 is expected. For this reason, in order to obtain 33% that is the target concentration value thereafter, the pump 47 is feedback controlled by increasing the transportation amount than the target, which is 33% as the target value of the control. With this, a solution at a desired concentration ratio can be obtained.

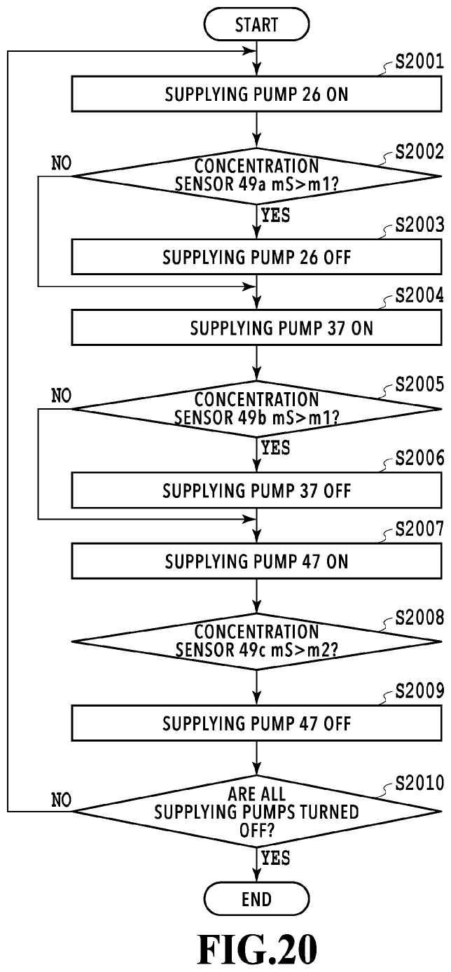

FIG. 20 is a flowchart illustrating processing for obtaining the concentration of the mixed solution 54 in portion (a) of FIG. 19. The processing for obtaining the concentration of a predetermined mixed solution 54 in the present embodiment is described below by using this flowchart. Once the processing for obtaining the concentration of a predetermined mixed solution 54 is started, driving of the supplying pump 26 is started in S2001, and the solution of the gas A is supplied to the mixing buffer chamber 53. Pure water is put in the mixing buffer chamber. Thereafter, in S2002, whether a concentration mS of the gas A is higher than a target concentration value m1 is determined by a concentration sensor 49a. If the concentration mS of the gas A is higher than the target concentration value m1, the process proceeds to S2003, and the driving of the supplying pump 26 is stopped. On the other hand, if the concentration mS of the gas A is not higher than the target concentration value m1, the concentration mS of the gas A does not reach the target concentration value m1 yet; for this reason, the process proceeds to S2004 without stopping the driving of the supplying pump 26.

In S2004, the driving of the supplying pump 37 is started, and the solution of the gas B is supplied to the mixing buffer chamber 53. Thereafter, in S2005, whether the concentration mS of the gas B is higher than the target concentration value m1 is determined by a concentration sensor 49b. If the concentration mS of the gas B is higher than the target concentration value m1, the process proceeds to S2006, and the driving of the supplying pump 37 is stopped. On the other hand, if the concentration mS of the gas B is not higher than the target concentration value m1, the concentration mS of the gas B does not reach the target concentration value m1 yet; for this reason, the process proceeds to S2007 without stopping the driving of the supplying pump 37.

In S2007, the driving of the supplying pump 47 is started, and the solution of the gas C is supplied to the mixing buffer chamber 53. Thereafter, in S2008, whether the concentration mS of the gas C is higher than the target concentration value m1 is determined by a concentration sensor 49c. If the concentration mS of the gas C is higher than the target concentration value m1, the process proceeds to S2009, and the driving of the supplying pump 47 is stopped. On the other hand, if the concentration mS of the gas C is not higher than the target concentration value m1, the concentration mS of the gas C does not reach the target concentration value m1 yet; for this reason, the process proceeds to S2010 without stopping the driving of the supplying pump 47. In S2010, whether all the supplying pumps are turned OFF is determined. If not all the supplying pumps are turned OFF, the process proceeds to S2001 and the processing is repeated. If all the supplying pumps are turned OFF, the processing for obtaining the concentration of the predetermined mixed solution 54 ends.

As described above, a mixed solution in which multiple types of gases are dissolved at a predetermined ratio is generated, and a UFB is generated by heating the mixed solution with a heating element. With this, it is possible to provide a generating method for generating a UFB at a desired component ratio, and a manufacturing apparatus and a manufacturing method for a liquid containing a UFB at a desired component ratio.

### SECOND EMBODIMENT

A second embodiment of the present invention is described below with reference to the drawings. Note that, since the basic configuration of the present embodiment is similar to that of the first embodiment, a characteristic configuration is described below.

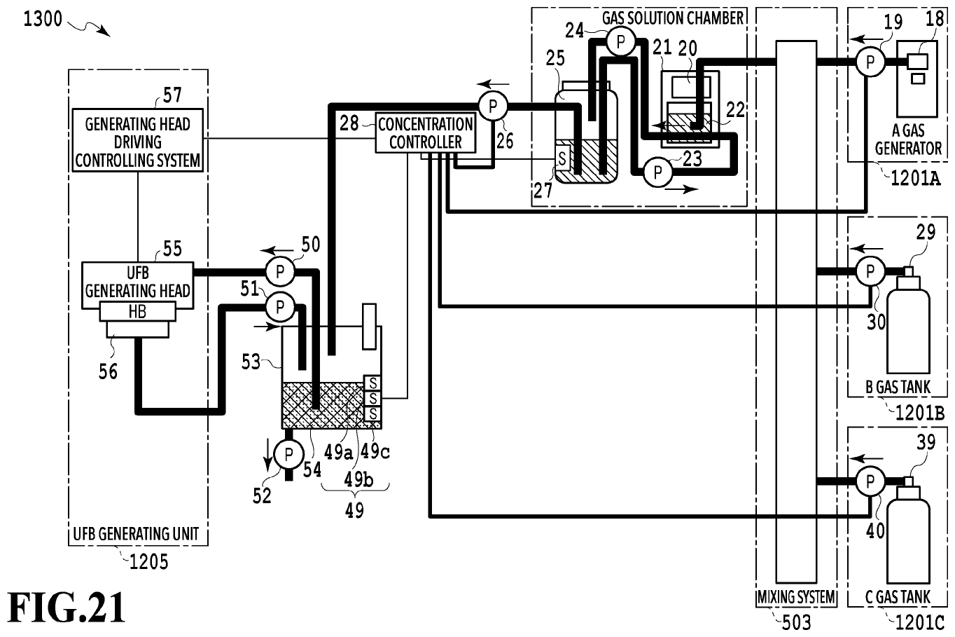

FIG. 21 is a schematic view illustrating a detailed configuration of a UFB generating system 1300 in the present embodiment. In the first embodiment, solutions in which gases are dissolved are generated, and thereafter a mixed solution in which the solutions are mixed with each other is generated; however, the UFB generating system 1300 of the present embodiment mixes the three types of gases, the gas A, the gas B, and the gas C, with each other while keeping the state of gas. A mixing system 503 is connected with the generators of the gases, the gas A, the gas B, and the gas C, and the gases supplied by supplying pumps 19, 30, and 40 are mixed with each other in the mixing system 503. The three types of gases mixed with each other in the mixing system 503 are supplied to the gas dissolving chamber 21, and a mixed solution is generated. The flow rates (supplying amounts) of the gases are controlled by the supplying pumps 19, 30, and 40 such that the inside of the mixing buffer chamber 53 is at a desired concentration in accordance with the solution concentration from the concentration sensor 49 in the mixing buffer chamber 53.

Note that, the supplying amounts of the gases may be controlled by the supplying pumps 19, 30, and 40 such that the inside of the dissolving buffer 25 is at a desired concentration in accordance with the solution concentration from the concentration sensor 27.

The configuration of the present embodiment is effective in a case where a gas that does not directly affect the mixing of gases is used and a case where the accuracy of mix ratio is not required to be high that much.

With the three types of gases, the gas A, the gas B, and the gas C, mixed while keeping the state of gas as described above, the gas dissolve system has a single configuration, and it is possible to implement a simple and inexpensive configuration.

### THIRD EMBODIMENT

A third embodiment of the present invention is described with reference to the drawings. Note that, since the basic configuration of the present embodiment is similar to that of the first embodiment, a characteristic configuration is described below.

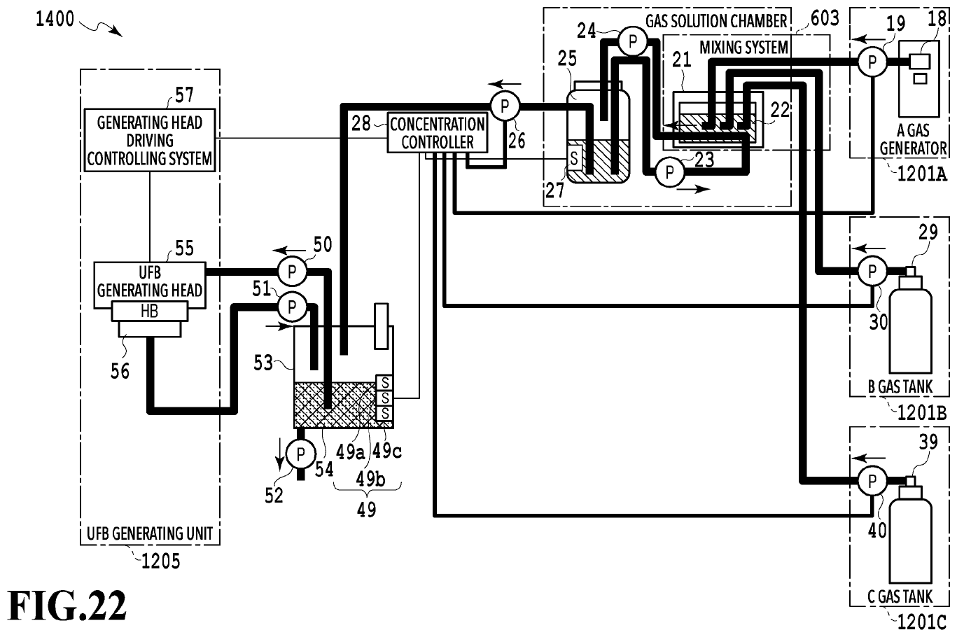

FIG. 22 is a schematic view illustrating a detailed configuration of a UFB generating system 1400 in the present embodiment. The UFB generating system 1400 of the present embodiment mixes the three types of gases, the gas A, the gas B, and the gas C, with each other at the same time in the gas dissolving chamber 21. A mixing system 603 is connected with the generators of the gases, the gas A, the gas B, and the gas C, and the gases supplied by the supplying pumps 19, 30, and 40 are mixed with each other in the mixing system 603, and a mixed solution is generated.

The supplying amounts of the gases are controlled by the supplying pumps 19, 30, and 40 such that the inside of the mixing buffer chamber 53 is at a desired concentration in accordance with the solution concentration from the concentration sensor 49 in the mixing buffer chamber 53. Note that, the supplying amounts of the gases may be controlled by the supplying pumps 19, 30, and 40 such that the inside of the dissolving buffer 25 is at a desired concentration in accordance with the solution concentration from the concentration sensor 27.

Also with the above method, the gas dissolve system has a single configuration, and it is possible to implement a simple and inexpensive configuration.

According to the present invention, it is possible to provide a generating method to generate a UFB in which a ratio of gas components in the UFB is a desired component ratio, and a manufacturing apparatus and a manufacturing method for a liquid containing a UFB at a desired component ratio.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An ultra-fine bubble generating method comprising:
a mixed solution generating step to generate a mixed solution in which a plurality of types of gases are dissolved at a predetermined dissolving ratio; and
an ultra-fine bubble generating step to generate an ultra-fine bubble by heating the mixed solution with a heating element and making film boiling on an interface between the mixed solution and the heating element.

2. The generating method according to claim 1, further comprising:
a first dissolving step to generate a first solution by dissolving a first gas into a liquid; and
a second dissolving step to generate a second solution by dissolving a second gas into a liquid, wherein
in the mixed solution generating step, the first solution and the second solution are mixed with each other at a predetermined ratio.

3. The generating method according to claim 2, wherein
the mixed solution generating step is performed in a mixing buffer chamber capable of retaining the mixed solution, and
based on a dissolving concentration of the first gas and the second gas retained in the mixing buffer chamber, the first solution and the second solution are mixed with each other at the predetermined ratio.

4. The generating method according to claim 1, further comprising:
a gas mixing step to mix the first gas and the second gas with each other at a predetermined ratio, wherein
in the mixed solution generating step, a mixed gas obtained in the gas mixing step is dissolved into a liquid.

5. The generating method according to claim 4, wherein
in the gas mixing step, based on a dissolving concentration of the first gas and the second gas in the mixed solution, the first gas and the second gas are mixed with each other at the predetermined ratio.

6. The generating method according to claim 5, further comprising:
a step of detecting the dissolving concentration in a mixing buffer chamber to which the mixed solution generated is supplied, the mixing buffer chamber being capable of retaining the mixed solution.

7. The generating method according to claim 5, further comprising:
a step of detecting the dissolving concentration in a gas dissolving chamber that dissolves, into the liquid, a mixed gas obtained in the gas mixing step.

8. The generating method according to claim 1, wherein
in the mixed solution generating step, a first gas and a second gas are dissolved into a liquid at a predetermined ratio.

9. The generating method according to claim 8, wherein
in the mixed solution generating step, based on a dissolving concentration of the first gas and the second gas in the mixed solution, the first gas and the second gas are dissolved into a liquid at the predetermined ratio.

10. The generating method according to claim 9, further comprising:
a step of detecting the dissolving concentration in a mixing buffer chamber to which the mixed solution generated is supplied, the mixing buffer chamber being capable of retaining the mixed solution.

11. The generating method according to claim 9, further comprising:
a step of detecting the dissolving concentration in a gas dissolving chamber that dissolves a first gas and a second gas into a liquid at a predetermined ratio.

12. The generating method according to claim 3, wherein
based on the dissolving concentration, driving of a first pump that adjusts a flow rate of the first gas and a second pump that adjusts a flow rate of the second gas is controlled.

13. A manufacturing apparatus for an ultra-fine bubble-containing liquid comprising:
a mixed solution generating unit that generates a mixed solution in which a plurality of types of gases are dissolved at a predetermined dissolving ratio; and
an ultra-fine bubble generating unit that generates an ultra-fine bubble by heating a mixed solution generated by the mixed solution generating unit with a heating element and making film boiling on an interface between the mixed solution and the heating element.

14. The manufacturing apparatus according to claim 13, wherein
the mixed solution generating unit includes a first solution generating unit that generates a first solution by dissolving a first gas into a liquid and a second solution generating unit that generates a second solution by dissolving a second gas into a liquid, and mixes the first solution and the second solution with each other at a predetermined ratio.

15. The manufacturing apparatus according to claim 14, wherein
the mixed solution generating unit includes a mixing buffer chamber capable of retaining the mixed solution, and
the mixing buffer chamber includes a concentration sensor that measures a dissolving concentration of the first gas and the second gas.

16. A manufacturing method for an ultra-fine bubble-containing liquid comprising:
a mixed solution generating step to generate a mixed solution in which a plurality of types of gases are dissolved at a predetermined dissolving ratio; and
a generating step to generate an ultra-fine bubble by heating a mixed solution generated in the mixed solution generating step with a heating element and making film boiling on an interface between the mixed solution and the heating element.
